(19) United States
(12) Patent Application Publication
(10) Pub. No.: US 2010/0062826 A1
(43) Pub. Date: Mar. 11, 2010

(54) METHODS AND APPARATUS FOR CONDUCTING LOTTERY GAMES

(76) Inventors: Jay S. Walker, Ridgefield, CT (US); Stephen C. Tulley, Monroe, CT (US); Daniel E. Tedesco, Huntington, CT (US); Robert C. Tedesco, Fairfield, CT (US); James A. Jorasch, New York, NY (US)

Correspondence Address: WALKER DIGITAL MANAGEMENT, LLC, 2 HIGH RIDGE PARK, STAMFORD, CT, 06905, US

(21) Appl. No.: 12/514,693

(22) PCT Filed: Nov. 14, 2007
(86) PCT No.: PCT/US07/84675

§ 371 Date: Oct. 7, 2009

Related U.S. Application Data
(60) Provisional application No. 60/865,752, filed on Nov. 14, 2006.

(51) Int. Cl. G06F 17/00

(52) U.S. Cl. 463/17; 463/43

(57) ABSTRACT

Systems, computer readable media and methods are presented that pertain to lottery games, which permit lottery players to reinvest their lottery entry winnings in one or more subsequent lottery drawings. In one embodiment, a method includes selling to a player at least one second lottery entry of a second lottery game in exchange for at least a portion of an initial payout, in accordance with at least one repurchasing action that corresponds to a repurchasing condition.

### CROSS-REFERENCE TO RELATED APPLICATIONS

This application claims the benefit of priority of PCT/US/07/84675 filed Nov. 14, 2007, which claims the benefit of priority of U.S. Provisional Patent Application No. 60/865,752 filed Nov. 14, 2006, which is incorporated by reference herein in its entirety.

### FIELD OF THE INVENTION

The present invention generally relates to systems, computer readable media, and methods that allow lottery players to reinvest their lottery entry winnings in one or more subsequent lottery drawings. More particularly, the disclosed apparatus and processes allow a player to reinvest at least a portion of a payout from a winning lottery entry of an initial lottery drawing by purchasing a second lottery entry of a subsequent, second lottery drawing in accordance with one or more repurchasing rules.

### BRIEF DESCRIPTION OF THE DRAWINGS

FIG. 1 is a flowchart of a process for reinvesting at least a portion of lottery winnings from a lottery entry of an initial lottery drawing by purchasing at least one lottery entry of at least one subsequent lottery drawing in accordance with an embodiment of the invention;

FIG. 2 is a simplified block diagram of a lottery system according to an embodiment of the invention that includes a plurality of lottery retailer terminals, a communications network, and a controller;

FIG. 3 is a simplified block diagram of an embodiment of a lottery retailer terminal;

FIG. 4 is a simplified block diagram illustrating an embodiment of a lottery operator controller;

FIG. 5 is a tabular representation of a lottery games database according to an embodiment of the invention;

FIG. 6 is a tabular representation of a player database according to an embodiment of the invention;

FIG. 7 is a tabular representation of a repurchasing rules database according to an embodiment of the invention;

FIG. 8 is a tabular representation of a lottery games results database according to an embodiment of the invention;

FIGS. 9A and 9B illustrate a lottery entry status database according to an embodiment of the invention;

FIG. 10 is a flowchart of a lottery terminal process for reinvesting at least a portion of lottery winnings from a lottery entry in accordance with an embodiment of the invention;

FIG. 11 is a flowchart of a process for repurchasing lottery entries in accordance with an embodiment of the invention;

FIG. 12 is a flowchart of a lottery operator controller process for repurchasing lottery entries for players according to one or more repurchasing rules in accordance with an embodiment of the invention; and

FIG. 13 is a view of a lottery ticket or lottery entry configured according to an embodiment of the invention.

### DETAILED DESCRIPTION

Many lottery players elect to play lottery games only in an effort to acquire a significant payout. In addition, many players who acquire small prizes involving nominal amounts as the result of a lottery game (for example, an on-line lottery game, and/or a lottery game involving a drawing wherein a certain amount of numbers or other indicia are selected, and/or an instant lottery game) may view the effort needed to redeem such small prizes as an unnecessary burden. For example, in order to claim a small cash prize or nominal prize amount (such as a prize amount of $1 or $3) resulting from a lottery drawing, a player may be required to make a separate return trip to the lottery retailer from which the player had originally purchased his or her entry.

A nominal prize amount may be defined as the lowest prize to be awarded for a particular lottery game drawing which usually involves a small dollar value (for example, a one dollar prize ($1) or a three dollar prize ($3)), or may be any prize amount designated by a lottery administrator that occupies one of the lowest three or four tiers of a multiple tier lottery game payout table. For example, in a pari-mutuel type of lottery game wherein each lottery entry costs one dollar ($1), the prize amounts may be divided into seven tiers, wherein the top prize occupies tier one and lesser prizes occupy the lowest six tiers. The prize amounts for each tier (or for the topmost tiers) may not be determined until the total amount spent on lottery entries for that lottery game is determined (that is, the total amount spent on lottery entries before a designated cutoff date, which may be the drawing date or some other designated deadline that is prior to the drawing date and time). For example, a tier amount prize distribution for a particular online lottery game may be: a tier seven prize of $1, a tier six prize of $3, a tier five prize of $7, a tier four prize of $10, a tier three prize of $100, a tier two prize of $1200, and a tier one prize of $15,000. Thus, the top prize (tier one) is $15,000, whereas the lowest prize amount (tier seven) is $1. In such a lottery game, the nominal prize amounts may be designated by a lottery administrator as being any of the lower tier prize amounts, which may be defined as all lottery game prizes in tiers four to seven (i.e., lottery game prize amounts of $10 or less). It should be understood that the nominal prize amount of a particular lottery game may be different, for example, being equal to a dollar amount that is more or less than $10, as designated by a lottery administrator.

In accordance with some embodiments, based on one or more player-selected rule(s), lottery winnings which may result from a first (initial) lottery event (for example, a first lottery drawing) may be utilized to automatically purchase (or repurchase) one or more lottery entry(ies) in a second, subsequent lottery event/lottery game. In an embodiment, a player, at the time of purchasing a lottery entry for the initial lottery event, may select or otherwise identify one or more repurchasing rule(s) that may include a repurchasing condition component and a repurchasing action component. In an embodiment, the identified repurchasing rule(s) may be used by a lottery administration system, for example, to determine whether and/or in what manner to repurchase one or more lottery entries for the subsequent lottery game.

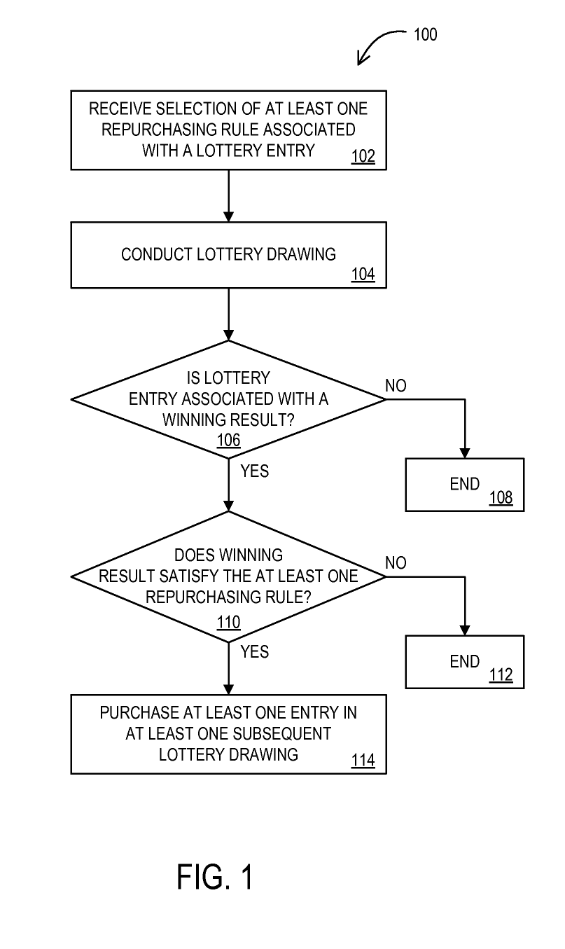

FIG. 1 is a flowchart 100 illustrating an implementation of a method for reinvesting at least a portion of lottery winnings associated with a lottery entry of a first lottery drawing in a subsequent, second lottery drawing. With respect to the flowcharts presented herein, other embodiments are contemplated and may not require all of the indicated steps, and/or may comprise steps performed in alternative sequences than those depicted. In addition, where databases are shown or described, the accompanying data is merely illustrative and not meant to be limiting with regard to content or configuration.

Referring to FIG. 1, in this example, at the time of purchase of his initial entry(ies) a player indicates which of a plurality of repurchasing rule(s) may be applied to winnings that result from the initial lottery event and can be used to enable or to allow the player to participate in the subsequent or second lottery event. In one implementation, the player selects or otherwise specifies at least one repurchasing rule to associate with his lottery entry, and a clerk inputs that selection at a point of sale (POS) terminal (or lottery terminal), which transmits the selected repurchasing rule with associated identifying data to a lottery controller. The repurchasing rule may include repurchasing conditions and repurchasing actions (which are discussed in detail below). The lottery controller receives 102 the selected repurchasing rule and associated data, and at a predetermined later time, conducts 104 the lottery drawing. The controller then determines 106 whether the lottery entry is associated with a winning outcome and/or winning result. If the lottery entry is not associated with a winning outcome, then the process ends 108. But if the lottery entry is associated with a winning result, then the lottery controller determines 110 whether or not at least one of the selected repurchasing rules is satisfied. If no repurchasing rule is satisfied, then the process ends 112; but if a repurchasing rule is satisfied then at least one second lottery entry is purchased 114 for at least one subsequent lottery drawing. In some embodiments, the process includes notifying the player that a subsequent lottery entry has been purchased.

A player may select and/or indicate repurchasing rules in various manners. For example, the player may indicate such rule(s) by: (i) selecting such rule(s) from one or more area(s) of a sense-mark form presented at the time of initial purchase; and/or (ii) otherwise indicate which rule(s) should be applied in determining whether the player should be eligible for the subsequent lottery event(s). For example, the player may provide a verbal indication to a cashier at the time she purchases her initial entries, which may then be input to a lottery terminal by the cashier on behalf of the player/purchaser.

In one embodiment, the process includes determining a result associated with a first lottery game, and then determining an initial payout associated with a lottery entry of a player of the first lottery game. The method also includes determining whether at least one repurchasing condition is satisfied, wherein the at least one repurchasing condition comprising a requirement that the initial payout is a lower tier prize amount associated with the first lottery game. And if the repurchasing condition is satisfied, the process includes selling to the player at least one second lottery entry of a second lottery game in exchange for at least a portion of the initial payout, in accordance with at least one repurchasing action that corresponds to the repurchasing condition.

In another example, the player may indicate a default selection that defines the manner by which winnings resulting from a first lottery event may be utilized to purchase lottery entries for one or more subsequent lottery event(s)/games. For example, a lottery operator or other authority may establish a preferred manner (a default manner) by which lottery winnings resulting from a first lottery game entry may be utilized to purchase one or more lottery entries in subsequent lottery game(s) and/or lottery drawings. For example, for a particular type of online lottery game, a lottery operator may make only the lowest payout(s) amounts (nominal lottery prize amounts) eligible for reinvestment, and such a payout(s) may be utilized at $1 per lottery entry for subsequent lottery games/drawings until such time that the payout amount is exhausted.

In accordance with one or more embodiments, player-specified (or player-elected) repurchasing conditions may enable players to set specific thresholds and/or conditions for establishing when and/or under what circumstances winnings from a first and/or initial game instance should be utilized to purchase lottery entries for a second or subsequent lottery game. For example, a player may be permitted to select a payout level, and winnings below that payout level may be utilized to purchase lottery entries in one or more subsequent lottery games and/or lottery drawings, but lottery prize winning amounts above that payout level are not reinvested in subsequent lottery entries. A player may also be permitted to chose one or more corresponding repurchasing actions that specify how his lottery winnings are to be allocated to purchase lottery entries in at least one subsequent lottery game.

Some described embodiments contemplate (among other things) the activation of a multi-draw subscription lottery entry pursuant to the satisfaction of one or more player-selected repurchasing conditions. Specifically, some of the disclosed methods, systems, and apparatus enable the activation of a multi-draw subscription lottery entry if and/or when a player qualifies for a payout in a first (initial) lottery drawing or game, and if and/or when a lottery operator allows such a multi-draw subscription lottery entry for players.

In some embodiments, if instructed by a player at the time of initial purchase of his or her entry (a first condition), any (and/or certain) resultant lottery winnings (for example, up to a specified amount of money such as five dollars) may be utilized to fund the purchase of a multi-draw subscription lottery ticket. For example, if a player qualifies for a $2 prize as the result of an initial lottery drawing (a second condition), then the resultant $2 prize may be used to fund the sequential purchase of one $1 entry in each of the two immediately-following lottery drawings (which is a subscription to two lottery games). In some embodiments, the player's initial lottery numbers and/or indicia are reactivated for each of the subsequent two lottery drawings. For example, with regard to the lottery game characteristics discussed immediately above, if the player's winning lottery entry was in a lottery game known as “pick-6”, and the player chose lottery indicia consisting of the combination of numbers “1, 6, 15, 27, 46 and 52”, then the same combination of lottery numbers would again be used when purchasing lottery entries in the subsequent two lottery drawings. Thus, some of the described embodiments encompass various methods, system and apparatus by which a lottery game player may purchase a multiple-drawing “subscription” lottery entry or lottery ticket, which may be activated or made eligible in one or more lottery drawing(s), pursuant to the satisfaction of one or more repurchasing conditions (which may be player-selected conditions).

In some described embodiments, the purchase price of a multi-draw lottery entry may be funded from (all or a portion of) winnings resulting from an initial lottery drawing or lottery game (instead of being an up-front, out-of-pocket cost to the player). In such an embodiment, the player may have an associated prize account that is tapped to pay for each subsequent lottery entry that is automatically sold to the player.

According to some embodiments, if the total collective payout for a set of one or more initial lottery entries is not greater than the lowest possible total non-zero prize for the entry(ies) collectively, then each entry in the set of one or more entries is automatically re-entered in the same subsequent drawing, or at least one entry is re-entered in one subsequent drawing and at least one other entry is re-entered in a different subsequent drawing. In some embodiments, the total collective payout must be equal to the lowest possible total non-zero prize for the set.

In some embodiments, the price for a set of one or more entries is equal to the lowest possible non-zero prize that any individual entry of the set could win, and if the player wins that lowest possible non-zero prize, all of the entries are re-entered automatically. For example, a set of three entries is priced at $3, and the lowest possible non-zero prize for any individual entry may also be $3. Should any one entry of the set of three entries qualify for the lowest possible non-zero prize (in this example, $3), the entire set of three entries may be subsequently entered into a second lottery game, in lieu of the initial $3 prize and/or based on a request received at the time of purchase of the initial set of three lottery entries.

### System Components

The following descriptions include a non-limiting list of general-purpose components including hardware, software and/or software processes and/or steps that may be employed to facilitate the purchase of one or more lottery entries in subsequent lottery drawing(s) and/or games. In general, as explained above, the purchase of one or more subsequent lottery game entries may be based on (i) the result of a lottery entry in a first lottery drawing or lottery game and (ii) one or more applicable repurchasing rule(s) that may include a repurchasing condition and a corresponding repurchasing action.

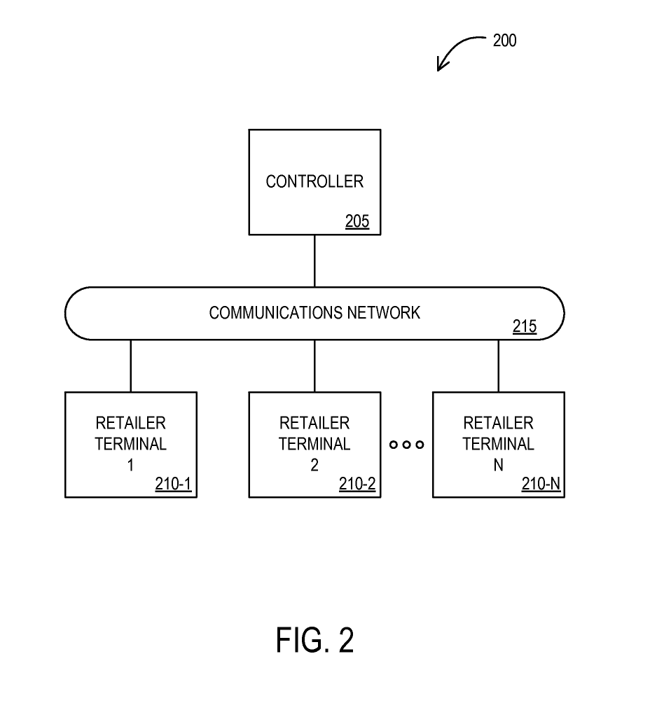

FIG. 2 is a simplified block diagram of a lottery system 200 that includes a lottery operator controller 205 operatively connected to a plurality of lottery and/or retailer terminals 210-1, 210-2 to 210-N through a communications network 215. Generally, any or all of the retailer terminals 210-1 to 210-N may operate to: (i) receive information associated with one or more lottery tickets including such data as: (a) lottery ticket and/or lottery entry identifier(s), (b) lottery entry indicia (such as lottery game entry numbers), (c) player identifiers, (d) lottery game conditions, (e) lottery entry repurchasing conditions, and (f) repurchasing actions. The retailer terminals may also operate to: (i) transmit any or all of the received information to the lottery controller 205 via the communications network 215; and (ii) output information such as data defining lottery entries, and information associated with winning lottery entries including repurchasing data.

In general, each retailer terminal 210-1 to 210-N shown in FIG. 2 will correspond to (or be associated with) a particular lottery retailer. For example, retailer terminal 1 (210-1) of FIG. 2 may be associated with a first lottery retailer such as a convenience store, and retailer terminal 2 (210-2) of FIG. 2 may be associated with a second lottery retailer such as a supermarket. It should be understood that any number of lottery retailer terminals might be employed in a system 200, along with any number of corresponding controllers 205.

The lottery operator controller 205 may operate to: receive and store information associated with one or more lottery entries including such data as: (a) lottery ticket and/or lottery entry identifier(s), (b) lottery game entry indicia, (c) player identifiers, (d) lottery game conditions, (e) repurchasing conditions, and (f) repurchasing rules. In addition, the lottery operator controller may operate to (i) conduct a lottery game drawing or receive information associated with an occurrence of a lottery game drawing and associate the winning lottery numbers and/or indicia with lottery entries; (ii) determine which of the winning lottery entries satisfies at least one repurchasing condition; and (iii) purchase (or repurchase) at least one lottery entry in accordance with a repurchasing action in at least one subsequent lottery drawing for a player. In some embodiments, the lottery controller 205 also operates to notify the player that one or more subsequent lottery entries have been purchased for the player in accordance with a repurchasing condition and corresponding repurchasing action (which may have been chosen by the player prior to the lottery game drawing).

In some embodiments, one or more of the retailer terminals 210-1 to 210-N of FIG. 2 may be configured to perform some or all of the functions of the controller 205. Thus, in some embodiments, the lottery operator controller 205 and a lottery retailer terminal 210-1 (or another given retailer terminal and controller pairing) may be considered as the same “device”.

Generally, the communications network of FIG. 2 may comprise or include one or more local and/or wide-area network(s), proprietary and/or public network(s) (such as the Internet) for facilitating two-way data communications between the retailer terminals 210-1 to 210-N and the lottery operator controller 205. The lottery controller may communicate with lottery retailer terminals directly or indirectly, via a wired or wireless medium such as the Internet, via a local area network (LAN), via a wide area network (WAN), via an Ethernet, via a Token Ring, a telephone line, a cable line, a radio channel, an optical communications line, a satellite communications link, or via any appropriate wired or wireless communications means or combination of communications means. Any number and type of devices may be in communication with the lottery controller, and communication between the lottery retailer terminals and the lottery controller 205 may be direct or indirect, such as over the Internet through a Web site maintained by computer on a remote server, or over an online data network including commercial online service providers, bulletin board systems and the like. In some embodiments, the devices may communicate with one another over RF, cable TV, satellite links and the like. A variety of communications protocols may be part of any such communications system, including but not limited to: Ethernet (or IEEE 802.3), SAP, ATP, Bluetooth™, and TCP/IP. In addition, communications between the retailer terminals and the controller may take place over a secure communications line and/or link (which may be wired or wireless), and/or data may be encrypted/decrypted or may otherwise occur under secure data transmission conditions and/or protocols.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for hours, days or weeks at a time. In some embodiments, a server computer or controller may not be necessary and/or preferred. For example, in one or more embodiments, methods described herein may be practiced on a stand-alone lottery game device and/or a device in communication only with one or more other lottery devices.

### Lottery Retailer Terminal

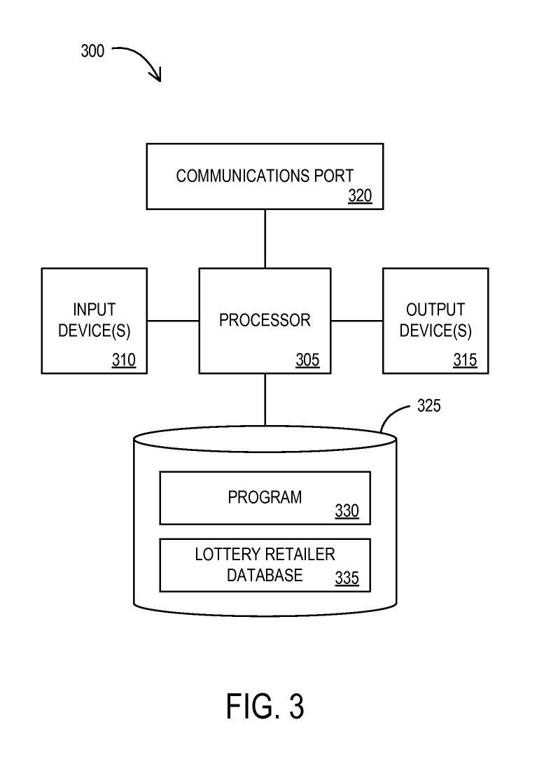

FIG. 3 is a simplified block diagram 300 of some exemplary components of a lottery retailer terminal. The lottery retailer terminal 300 may include one or more processor(s) 305 such as the PENTIUM® processor, manufactured by INTEL Corporation, or other processors manufactured by other companies, such as the AMD Athlon® processor manufactured by the Advance Micro Devices company. Generally, the processor is operative to perform or process instructions, and in particular, to operate in accordance with the various methods described herein. For example, the processor 305 may be operable to allow the lottery retailer terminal 300 to transmit data to (and receive data from) the controller 205 of FIG. 2. More specifically, the processor 305 may enable the transmission of data defining or identifying a lottery ticket or entry, a player ID, and/or repurchasing rules and other data.

Accordingly, the lottery retailer terminal 300 may further include one or more input device(s) 310. The input devices may include components such as an optical scanner and/or a barcode scanner, for reading and/or for deriving information associated with a lottery entry. For example, a lottery ticket may include registration marks, authenticity data, various codes, micro-printed indicia, one or more sense marks, and/or other lottery entry indicia that must be read, for example, to distinguish between two or more lottery entries (which may all be contained on one lottery ticket, for example). Examples of additional input devices include, but are not limited to, a keypad, a mouse, an image capturing device (for example, an optical character recognition (OCR) device), a biometric reader, a portable storage device (such as a memory stick), and the like.

According to some embodiments, the lottery retailer terminal input device(s) 300 may comprise or include a clock. The clock may be employed to detect, derive and/or append time and/or date information for use by the controller 205 to: (i) create a data record corresponding to lottery tickets or lottery entries purchased at the lottery retailer terminal 300, and/or (ii) to determine redemption time and/or date information associated with lottery tickets and/or lottery entries.

The lottery retailer terminal 300 of FIG. 3 may further include one or more output device(s) 315. Such output device(s) 315 may include such components as a display for outputting information to a lottery player or to a lottery terminal operator (such as win/loss information, payout amounts, and an indication of selected repurchase rules that may be selectable by the player), one or more benefit output devices (such as a cash drawer, or a currency dispenser), a printer for producing a physical record (such as a paper slip, receipt, ticket, voucher, coupon, etc.) that defines a lottery ticket or lottery entry, audio/video output device(s), and the like.

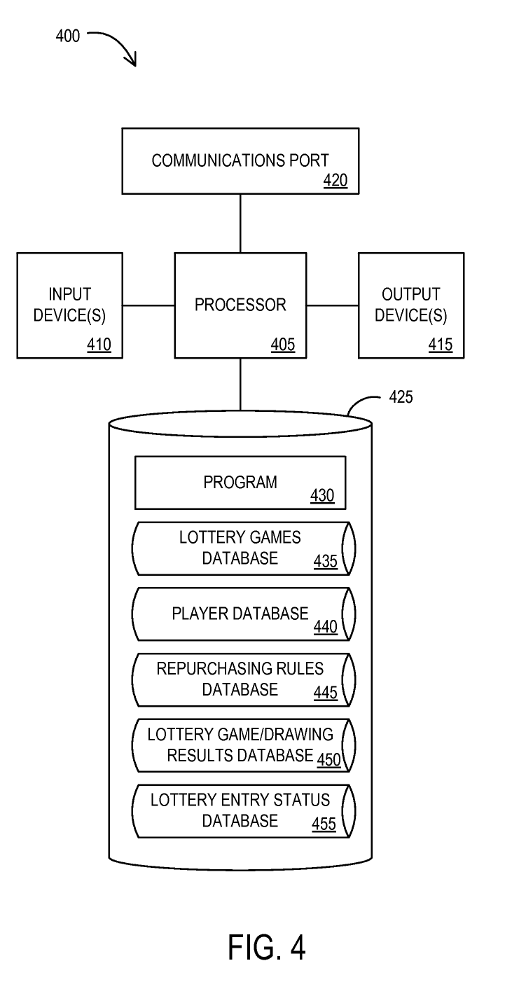

The lottery retailer terminal 300 may also include one or more communications port(s) 320, such as a serial port, cable modem, wireless transmitter/receiver or the like. Generally, the communications port 320 may be operable to facilitate two-way data communications between (i) the lottery retailer terminal 300 and (ii) the lottery operator controller 205 shown in FIG. 2 (or lottery operator controller 400 shown in FIG. 4, described below). In some embodiments, the communications port 320 may operate to facilitate the transmission of information between the lottery retailer terminal 300 and a player device such as a personal digital assistant (PDA), cell phone and/or a dedicated (e.g., a proprietary) device.

The lottery retailer terminal 300 may further include a data storage device 325 such as a hard disk, optical or magnetic media, random access memory (RAM) and/or read-only memory (ROM), or the like memory device. Generally, the lottery retailer terminal data storage device 325 stores a software program 330, the software program enabling the processor 305 of the retailer terminal 300 to perform various functions including some or all of the various steps described herein. In addition, the data storage device 325 may include one or more lottery retailer databases 335 for storing lottery data such as lottery game information, repurchasing rules data, lottery entry purchase data, and the like.

For example, as noted above with respect to FIG. 2, in accordance with some embodiments, the retailer terminal 300 may be configured to perform some or all of the functions of the lottery controller 205 (and vice versa) such that the lottery controller and the lottery retailer terminal 300 (or, referring to FIG. 2, a given lottery terminal and controller pairing) may be considered as the same “device”. An example retailer terminal available in the marketplace is the EXTREMA® clerk-operated lottery terminal, distributed by Scientific Games Corporation of Alpharetta, Ga.

In some embodiments, a lottery sales device may be utilized in place of a lottery retailer terminal 300. Such a lottery sales device may be implemented as a system controller, a dedicated hardware circuit, an appropriately programmed general-purpose computer, or any other equivalent electronic, mechanical or electro-mechanical device. Thus, in various embodiments, a lottery sales device may comprise, for example, a Video Lottery Terminal that may include a touch sensitive screen for use by a player, a personal computer (for example, a laptop computer operable to communicate with a remote lottery server), a vending machine, a kiosk, a telephone, or a portable handheld device (for example, a device similar to a personal digital assistant (PDA) or other analog or digital communications device). The lottery sales device may comprise any or all of the devices of the aforementioned systems. In some embodiments, a user device such as a PDA, cell phone, and/or portable gaming unit (such as the Playstation™ Portable (PSP), distributed by Sony Corporation) may be used in place of, or in addition to, some or all of the device components.

### Lottery Operator Controller

FIG. 4 is a simplified block diagram illustrating an embodiment of the components of a lottery operator controller 400. Similar to the lottery retailer terminal 300 of FIG. 3, the lottery operator controller 400 may include one or more processor(s) 405 such as the PENTIUM® processor manufactured by INTEL Corporation, or the AMD Athlon® processor manufactured by the Advance Micro Devices Company. Such a processor 405 functions to process instructions, and in particular, to operate in accordance with various methods described herein. For example, the processor 405 may operate to allow the lottery operator controller 400 to transmit data to (and receive data from) the lottery retailer terminal 300 shown in FIG. 3. More specifically, the controller processor 405 may enable the transmission of data defining or identifying a lottery ticket or lottery entry, as well as information identifying a player, and defining one or more payout(s) associated with one or more lottery entries of that lottery ticket, to a specific one of the lottery retailer terminals 210-1 to 210-N shown in the lottery network 200 of FIG. 2. Thus, the lottery operator controller may be implemented as a system controller, a dedicated hardware circuit, an appropriately programmed general-purpose computer, or any other equivalent electronic, mechanical or electro-mechanical device. In various embodiments, a lottery operator controller may comprise, for example, a personal computer (which may communicate with a remote lottery sales terminal) or mainframe computer.

The lottery operator controller 400 may further include one or more input device(s) 410. Examples of such input devices include a keypad, a mouse, a touch-screen, a random number generator, a microphone, and other digital or analog input devices. According to some embodiments, the lottery operator controller input device(s) 410 may comprise or include a clock. As described above, the clock may be employed to derive time and/or date information.

The embodiment of the lottery operator controller 400 further includes one or more output device(s) 415. Example of output devices 415 include a monitor or other display for outputting information to a user of the lottery operator controller (for example, for displaying information such as repurchasing rules (which may include repurchasing conditions and corresponding repurchasing actions), player conditions, statistical or sales data, win and loss information, and/or payout amounts), a printer for producing a physical record (such as a report, a paper slip, a voucher, a coupon, a ticket) of such data, and the like. In addition, the lottery operator controller 400 may include one or more communications ports 420, such as a serial port, cable modem, wireless transmitter/receiver or the like, operable to facilitate two-way data communications between (i) the operator controller 400 and (ii) one or more lottery retailer terminals 300, as described above with respect to FIGS. 2 and 3.

The lottery operator controller 400 may also include a data storage device 425 (such as a hard disk or hard drive, a media-based (removable) memory, flash memory, virtual memory, or the like). In some embodiments, the lottery operator controller data storage device 425 stores at least one software program 430, which includes a program to enable the processor 405 to perform some or all of the various steps and functions of at least one implementation of the methods described in detail herein (for example, the process 100 for reinvesting at least a portion of lottery winnings from a lottery entry of an initial lottery drawing by purchasing at least one lottery entry of at least one subsequent lottery drawing explained above with respect to FIG. 1). In addition, the lottery operator controller data storage device 425 may operate to store (i) a lottery games database 435 (described in more detail below), (ii) a lottery player database 440, (iii) a repurchasing rules database 445, (v) a lottery game/drawing results database 450, and (vi) a lottery entry status database 455. The databases 435 to 455 are described in more detail below.

In some embodiments, the lottery operator controller 400 may include a lottery ticket server device that may be located at a lottery ticket printing facility, and may also function to manage a ticket printing process. The lottery operator controller may also function to develop the lottery game matrix (e.g., determining payouts, win frequencies and the like). In some embodiments, a lottery ticket printer device for use in such lottery systems may utilize the game matrix information from the lottery server and may apply it to secure paytable data.

### Other Devices

In some embodiments, a kiosk (not shown) may be configured to execute or assist in the execution of various lottery game functions and/or processes that are described herein. In an implementation, a kiosk may comprise a processor and a storage device or memory as described above. A kiosk may also comprise various input devices (such as a touch screen, a keyboard, a mouse, buttons, an optical scanner for reading barcodes or other indicia, a CCD camera, and the like), output devices (such as a display screen, audio speakers, and the like), benefit output devices (such as a coin tray and/or a currency dispenser), communications ports, and the like. A kiosk may be configured to communicate with a lottery controller and/or lottery server.

In some embodiments, players may use one or more computing devices to obtain more information about the lottery games, perform operations such as selecting repurchasing rules, view lottery game history data, and/or monitor lottery game entries for lottery games that the player is playing. For example, a player may utilize a personal computer such as a laptop computer to access a lottery operator website that contains lottery game information, lottery game instructions, repurchasing rules, winning lottery entry payout information that includes the drawn winning lottery numbers and/or indicia, and the like.

### Lottery Games Database

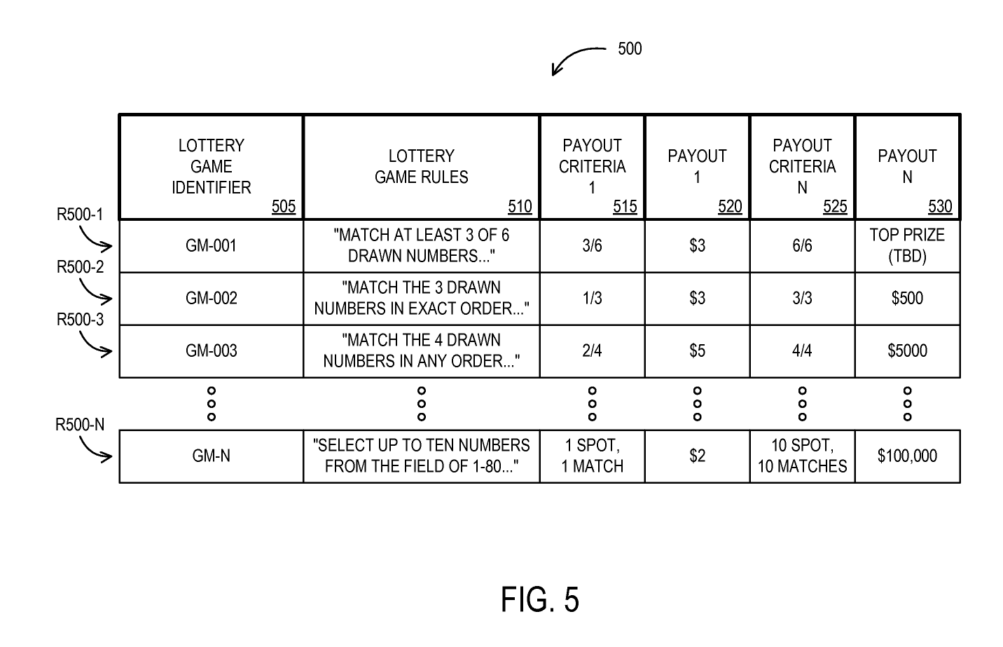

FIG. 5 is a tabular representation of an embodiment of a lottery games database 500. The lottery games database 500 stores data associated with one or more lottery games and/or lottery game formats. It should be understood that the various database examples described herein include illustrative accompanying data as shown in the drawings. Consequently, the data appearing in the drawings concerning the disclosed databases is exemplary in nature, and such data entries are not limiting with regard to functionality or to the types of data that may be stored therein. It should also be understood that the structure or configuration of the tabular databases described herein is not limiting, as one skilled in the art understands that other database configurations of fields, records and files could also be employed.

In the embodiment of FIG. 5, each record in the lottery games database generally defines a game available for play and/or available for the purchase of lottery entries by a lottery player. In particular, for each game defined by an entry in the lottery games database 500, a game identifier field 505 stores data that uniquely identifies the lottery game of the corresponding record. The data stored in the game identifier field 505 may comprise, for each available game, a unique numeric, alphanumeric or other type of code that uniquely identifies the lottery game defined by the corresponding entry.

For each lottery game identified by an entry in the game identifier field 505, one or more associated lottery game rules field(s) 510 may store data or information, including a textual description of the criteria required of a lottery entry to be successful (to win a prize) in the corresponding lottery game. For example, referring to row R500-1, the game identified as “GM-001” in the game identifier field 505 may correspond to lottery game rules for a standard “Pick 6” on-line lottery game, wherein a player selects six numbers and winning lottery entries match at least 3 of 6 drawn numbers. The lottery games database 500 also includes a Payout Criteria 1 field 515, Payout 1 field 520, Payout Criteria N field 525 and a Payout N field 530. For any particular “Pick-6” lottery game, more or less payout criteria and payout fields could be included, which will be explained in more detail below.

For example, the Connecticut Lottery Corporation provides a “Pick-6” on-line lottery game called “Classic Lotto” wherein players go to a lottery retailer and fill out a “Classic Lotto Play Slip” by choosing six different numbers from the ordinal range of 1 to 44 (inclusive) in each individual play section or board (alternately, a computer can randomly pick the numbers for the player, if the player so chooses). Players of “Classic Lotto” can play up to five boards on each selection slip (lottery ticket), and pay one-dollar per entry. For example, a lottery player can pay a clerk at a lottery retailer five dollars to purchase five lottery entries, wherein each lottery entry includes six numbers selected from the 44 available choices. Thus, the player may fill in a pay slip and hand it to the clerk, who then enters the pay slip into the retailer terminal. The lottery terminal then issues a printed “Classic Lotto” ticket for the player. The player keeps the lottery ticket until the drawing for that lottery game, and then compares the numbers/lottery indicia of his lottery entries to the drawn numbers to determine if he has won any prize(s).

Referring again to FIG. 5, row R500-1 shows a Pick-6 lottery game identified as “GM-001”, and the payout criteria field 515 indicates that if the player matches 3 out of 6 drawn numbers, then a payout of three (3) dollars is made (see Payout 1 Field 520). Larger payouts would also be determined for matching 4 out of 6 and for matching 5 out of 6 numbers as well (which payout criteria and prize amounts is not shown). The Payout Criteria N field 525 indicates that a win of 6 out of 6 matches pays out the top prize, and the top prize is yet to be determined as shown in Payout N field 530 (shown as “TBD”, which means “To Be Determined”), because the top prize is typically calculated by the lottery authority as a percentage of the total amount of money spent by all players to purchase lottery entries, and the calculation may also include other variables that would serve to either increase or decrease the top prize value).

FIG. 5 thus illustrates that, for each game corresponding to an entry in the game identifier field 505, one or more payout criteria fields (515 and 525) and a corresponding payout field (520 and 530) store data specifying the actual criteria and corresponding payouts for lottery tickets that satisfy such criteria. For example, using the “Pick-6” example above, the lottery games database 500 could include payout criteria and corresponding payouts for such a game as shown in the following paytable:

| Criteria | Payout |
|---|---|
| Match 0/6 | 0 |
| Match 1/6 | 0 |
| Match 2/6 | 0 |
| Match 3/6 | $3 |
| Match 4/6 | $50 |
| Match 5/6 | $2,000 |
| Match 6/6 | Win Jackpot/Top Prize |

FIG. 5 also includes data for other lottery games. In particular, row R500-2 contains data for lottery game GM-002, which is a “Pick-3” type of game. Thus, the data includes a game rule 510 wherein a player must match the three drawn numbers in exact order. The payout criteria 1 field 515 for matching one number out of the three drawn in the correct order corresponds to a nominal-level payout value of three-dollars as shown in the Payout 1 field 520. In addition, a payout criteria for matching two out of three numbers (not shown) is stored, and payout criteria N (which is the third criteria in this example) recites that if the player matches all three numbers in order, then that lottery ticket corresponds to a high-level base payout 530 of five hundred dollars.

Referring to row R500-3, the lottery game GM-003 corresponds to a “Pick-4” type of game, and includes a game rule 510 wherein a player may match up to four drawn numbers in any order. The Payout Criteria 1 in field 515 for matching two numbers out of the four drawn corresponds to a nominal-level payout value of five-dollars as shown in Payout 1 field 520. In addition, Payout Criteria N (which is the fourth criteria for this example) recites that if the player matches all four numbers (in exact order) then a high-level payout 530 of five thousand dollars is made. As explained earlier, the database 500 also includes entries for matching three out of the four numbers (with associated payout amounts) as well.

Lastly, Row R500-N corresponds to lottery game GM-N, which is a “Pick-10” type of game that includes a game rule 510 specifying that a player may select up to 10 numbers from a field or board of 80 numbers. If a player only picks one spot (that is, he only picks one number) as specified in the Payout 1 field 515, and that spot matches a drawn number then the player wins a nominal-level two-dollar prize as shown in the Payout 1 field 520. However, if the player picks ten spots and all ten match the drawn numbers as specified in Payout Criteria N field 525, then as shown in Payout N field 530 he is entitled to a high-level, one-hundred thousand dollar prize. As explained above, database entries would also exist to include all intermediate winning combinations, for example, payout amounts for obtaining three out of three matches numbers, four out of four matches, four out of five matches, five out of five matches (and possibly prizes for matching most numbers of a group, such as obtaining five out of six matches, six out of seven matches, and the like), and any other matching sets or match permutations as desired.

### Player Database

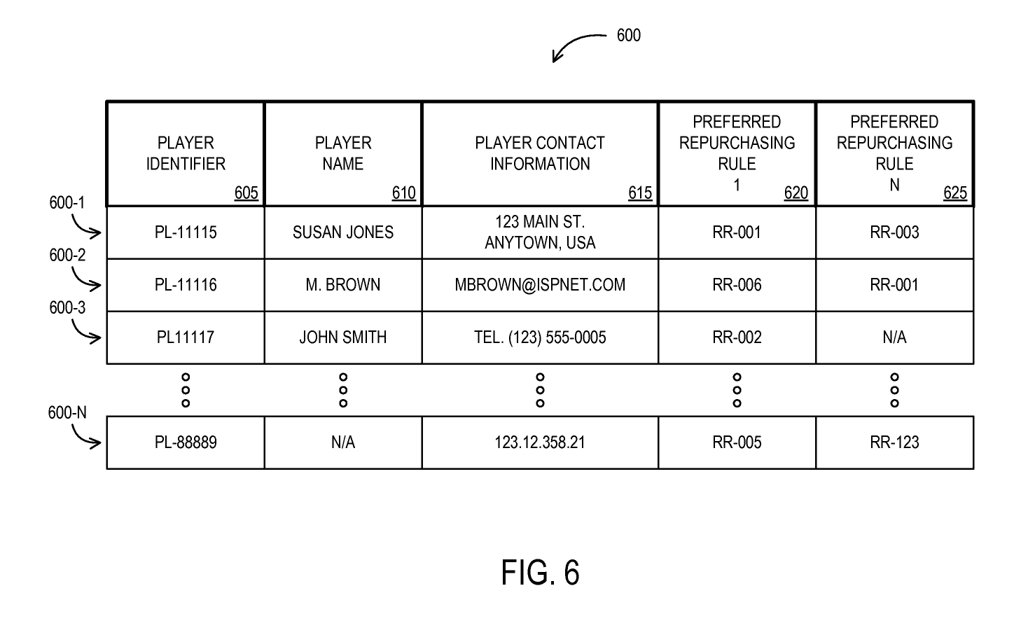

FIG. 6 illustrates an exemplary embodiment of a player database 600, which may include multiple records having multiple fields for storing data. Specifically, the player database 600 comprises multiple records, each record being associated with a particular player, as identified by a code in a Player Identifier field 605. The fields within each record may include, for example, a Player Name 610, Player Contact Information 615 (which may include, for example, the player's residence address, email address, phone number, and the like, or any combination thereof), a Preferred Repurchasing Rule 1 field 620, and a Preferred Repurchasing Rule N field 625. Thus, having information related to one field, such as Player ID 605, allows the lottery operator controller 400 to retrieve or access further information stored in the other fields of that player's record.

It is to be understood that some of these identifying fields may not be absolutely necessary, and that the illustrated configuration of the player database 600 may also not be necessary, but the data entries and format of the database as shown may be desirable for particular embodiments and applications of the methods described herein. Specifically, the Player Identifier 605, Player Name 610, Player Contact Information 615, Preferred Repurchasing Rule 1 field 620, and Preferred Repurchasing Rule N field 625 are merely representative of additional information that may be stored and used for certain purposes. But some embodiments of the processes described herein may require additional entries, for example, a financial account number field (for example, a credit card number field) for use for billing purposes and crediting purposes, and or a “conditions” field that may further define one or more repurchasing rules. In another example, a social security number field may be included and used to generate tax forms when a player wins a payout over a given amount. In another example, only the Player Identifier 605, Player Contact Information 615, and Preferred Purchasing Rule 1 field 620 may be necessary or desirable for a particular application.

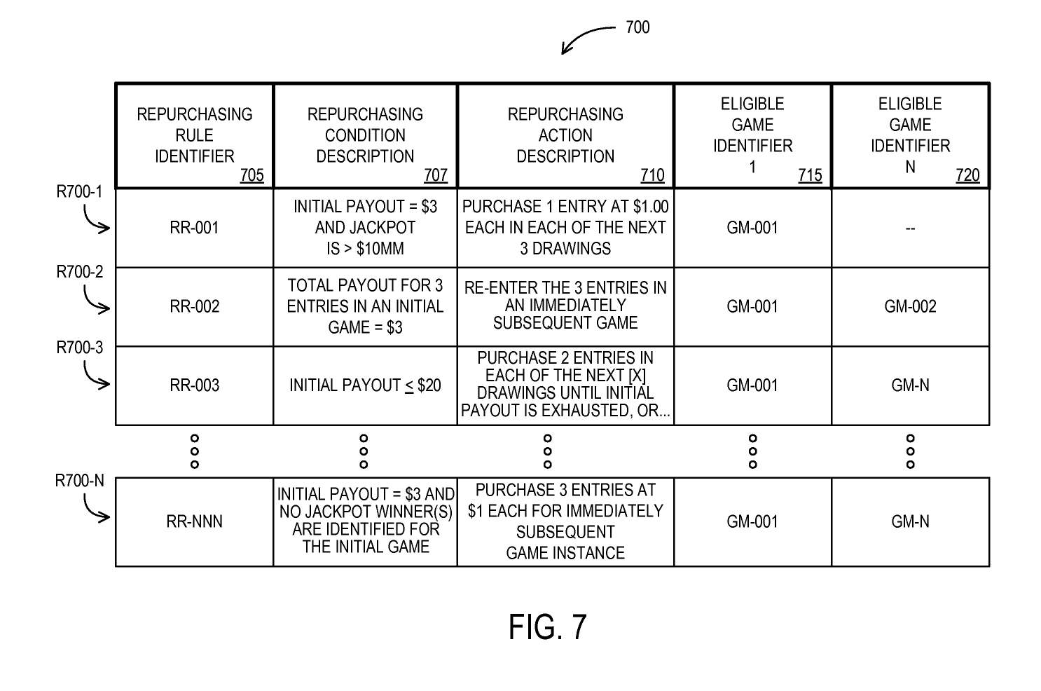

Referring again to FIG. 6, the tabular database includes an entry in rows 600-1 to 600-N for each player in the database. For example, the identifier is PL-11115 of row 600-1 is assigned to “Susan Jones”, and her contact information and preferred purchasing rules are also included. In particular, her associated Preferred Purchasing Rule 1 (field 620) is “RR-001”, which corresponds to a first repurchasing rule of a plurality of repurchasing rules (which will be explained in more detail below with reference to FIG. 7). The player Susan Jones also has a Preferred Purchasing Rule N (field 625) of “RR-003”, which corresponds to another of the repurchasing rules, different than “RR-001”. As shown in FIG. 6, different players may have selected different repurchasing rules as their preferred rules, and some, such as “John Smith” (row 600-3) may only have one preferred rule (“RR-002” in field 620), while others such as “M. Brown” (row 600-2) have two or more preferred rules (“RR-006” in field 620, and “RR-001” in field 625). The last row depicted in FIG. 6, row 600-N includes a player identifier of PL-88889, does not include a player name entry, includes a network address of 123.12.358.21, and shows the preferred purchasing rules “RR-005” and “RR-123”. As mentioned above, other fields may also be included in the database 600.

### Repurchasing Rules Database

FIG. 7 illustrates an exemplary embodiment of a repurchasing rules database 700, which may include multiple records having multiple fields for storing data. Specifically, the Repurchasing Rules Database 700 comprises multiple records, each record being associated with a particular repurchasing rule, as identified by a code in a Repurchasing Rule Identifier field 705. The fields within each record may include, for example, a Repurchasing Condition Description 707, a Repurchasing Action Description 710, an Eligible Game Identifier 1 field 715, and an Eligible Game Identifier N field 720. Thus, having information related to a Repurchasing Rule Identifier 705 allows the lottery operator controller 400 to retrieve or access further information stored in the other fields of the database corresponding to that particular repurchasing rule.

It is to be understood that the illustrated design or configuration of the Repurchasing Rules Database 700 may not be necessary, but the entries and format of the database may be desirable for particular embodiments and applications of the methods described herein. Specifically, the Repurchasing Rule Identifier 705, Repurchasing Condition Description 707, the Repurchasing Action Description 710, the Eligible Game Identifier 1 field 715, and the Eligible Game Identifier N field 720 are representative of information that may be stored and used for certain purposes. But some embodiments, for example, may require additional entries such as multiple “Eligible Game Identifier” fields and other types of “Conditions” fields that may correspond to some, but not all, of the repurchasing rule identifiers. In addition, it should be understood that various other combinations of repurchasing conditions and corresponding repurchasing actions that serve to define any of the particular repurchasing rules shown in FIG. 7 may be provided for use together as deemed practical by a lottery administrator, for example, or by a player, for any desired application and/or lottery game. For example, referring to repurchasing rule RR-001 of FIG. 7, the repurchasing condition described in field 707 could be combined with the repurchasing action described in field 710 of rule RR-002 or RR-NNN to define a different repurchasing rule. Thus, different combinations of repurchasing conditions and corresponding repurchasing actions are contemplated, and may be created and/or defined as repurchasing rules by a lottery administrator, and such repurchasing rules may be listed and offered to lottery players for selection.

Referring again to FIG. 7, in some embodiments the tabular database includes an entry in rows 700-1 to 700-N for each repurchasing rule in the database, including a repurchasing condition and a corresponding repurchasing action. For example, the identifier RR-001 of row 700-1 corresponds to a repurchasing rule that is described in the Repurchasing Rule Condition field 707 as requiring an “Initial payout equal to three dollars, and a jackpot amount greater than $10 million dollars”, and if this condition is satisfied, a Repurchasing Action 710 of “Purchase one entry at $1 each in each of the next three drawings” is enacted, to sell the player one entry in each of the next three lottery games. Row 700-1 also specifies an Eligible Game Identifier field 1 (715) of “GM-001”. Thus, if a player selected repurchasing rule RR-001 before the lottery drawing for the lottery game “GM-001” and wins a lower tier prize amount or nominal lottery prize amount of three dollars as a payout, then that player will automatically be sold and/or receive three lottery entries in each of three subsequent lottery games that correspond to identifier “GM-001”.

R700-2 of FIG. 7 also shows the repurchasing rule identifier “RR-002” that includes a repurchasing condition shown in field 707 as “Total payout for three entries of an initial lottery game equals three dollars”, and corresponding repurchasing action in field 710 of “Re-enter the three lottery entries in an immediately subsequent lottery game”. In this case, the entry in Eligible Game Identifier 1 field 715 is “GM-001”, and the entry in Eligible Game Identifier 2 field 720 is “GM-002”. Thus, a player who selected repurchasing rule “RR-002” and won a lower tier lottery game payout of $3 and purchased three lottery entries will automatically be sold/receive three lottery entries in a subsequent lottery game that corresponds to either of identifier “GM-001” or “GM-002”. It should be noted that this repurchasing rule RR-002 includes a repurchasing condition 707 that requires the player to make an initial first purchase of three dollars (for example, for a lottery game that only requires a minimum purchase amount for one entry of $1) and requires that a lower tier payout of $3 is the result, in order that the repurchasing action 710 will be enacted to automatically sell that player three lottery entries in the next subsequent lottery game identified by either of the game identifiers GM-001 or GM-002. Thus, such a repurchasing rule may be utilized by a lottery administrator to encourage players to purchase multiple lottery entries for an initial lottery drawing (in this case, purchase three, one-dollar entries for $3 instead of purchasing only one entry for $1), and such an incentive may increase overall lottery ticket and/or lottery entry sales for certain lottery games by affording an added convenience to players who purchase an increased number of individual entries.

Again referring to FIG. 7, in row R700-3 the repurchasing rule identifier “RR-003” corresponds to a repurchasing condition described in field 707 as an “Initial payout less than or equal to $20”, and having a repurchasing action 710 of “Purchase two lottery entries in each of the next “X” drawings until the payout is exhausted, or . . . ”. Thus, the repurchasing action in this case may include alternative and/or additional repurchasing actions. Also, for rule “RR-003”, the entry in Eligible Game Identifier 1 field 715 is “GM-001”, and the entry in Eligible Game Identifier 2 field 720 is “GM-N”. Thus, for a player who selects repurchasing rule “RR-003” and wins a payout of $20 or less, that player will automatically be sold/receive lottery entries in subsequent lottery games that correspond to any of identifiers “GM-001” to “GM-N” until the initial payout is exhausted, or until some other provision is satisfied (for example, that player wins a lottery prize of $20 or more).

Again referring to FIG. 7, Row R700-N includes a repurchasing rule identifier “RR-NNN” which is a repurchasing rule that includes a repurchasing condition 707 of “Initial payout equals three dollars and no lottery jackpot winners are identified for the initial game”, which if satisfied causes the repurchasing action 710 of “Purchase three lottery entries at $1 each for immediately subsequent game instance”. The entry in this case for the Eligible Game Identifier 1 field 715 is “GM-001”, and the entry in Eligible Game Identifier 2 field 720 is “GM-N”. Thus, for a player who selects repurchasing rule “RR-NNN” and wins a lower tier lottery game prize payout of $3, that player will then automatically receive three lottery entries in each of three subsequent lottery games that correspond to any of the identifiers “GM-001” to “GM-N”.

### Game Results Database

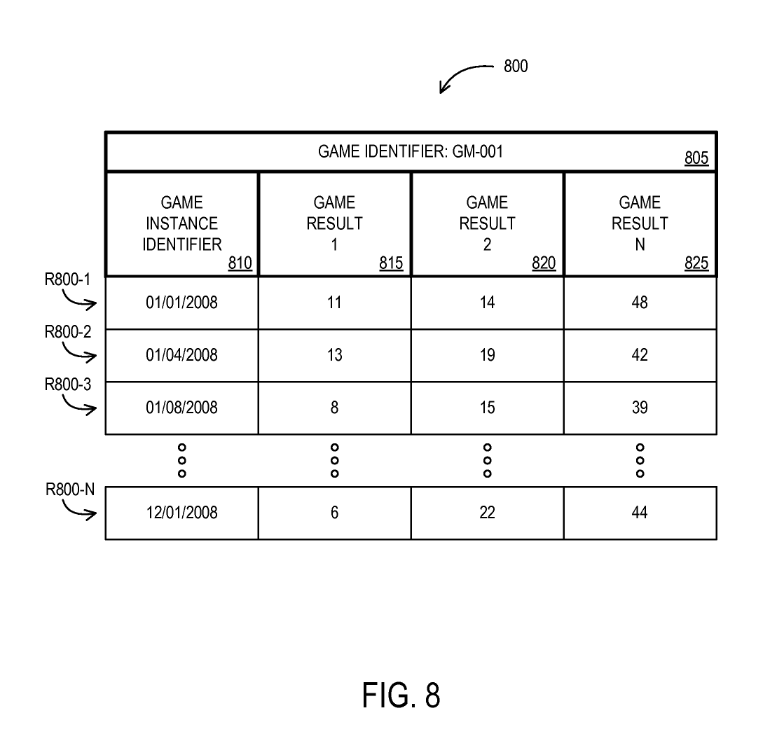

FIG. 8 depicts a tabular representation of an embodiment of a Lottery Games Results Database 800 that may correspond to a lottery game such as the “Pick-6” lottery game, and/or to another on-line lottery game. The database 800 includes a Game Identifier 805, which in this example corresponds to “GM-001” that identifies the particular lottery game (or type of game) associated with lottery entries purchased by players. The database 800 also includes a Game Instance Identifier field 810 for storing data identifying a particular instance (e.g., a lottery drawing) associated with the particular lottery game. For example, as shown in FIG. 8, the information stored in the game instance identifier field 810 may include the date and/or a time identifying the particular instance (for example, the drawing time and date of winning numbers) of that lottery game. The database 800 also includes Game Result 1 field 815, Game Result 2 field 820, and Game Result N field 825. Theses game result fields correspond to each indicia drawn during a game instance. For example, the game identifier “GM-001” may correspond to a “Pick-6” type of lottery game, and if so then “N” equals six, and six “Game Result” fields would be provided in the database 800. It should also be understood that in some disclosed embodiments, the Game Results Database 800 may require additional entries such as a “Lottery Game Instance Expiration Date” field that may correspond to some, but not all, of the game instance identifiers.

Referring to FIG. 8, rows R800-1 to R800-N include game results for particular game instances of the lottery game that corresponds to game identifier GM-001. For example, the lottery game having a drawing on Jan. 1, 2008 (row R800-1) includes winning numbers 11 (field 815), 14 (field 820), and 48 (field 825). More or less such fields could be employed for different types of lottery games, for example, ten fields could be employed for a “Pick-10” type lottery game. The winning indicia information and other data of the Game Results Database may be used in concert with data stored in other databases, for example with the data included in the Games Database 500 of FIG. 5, to practice the methods described herein.

### Entry Status Database

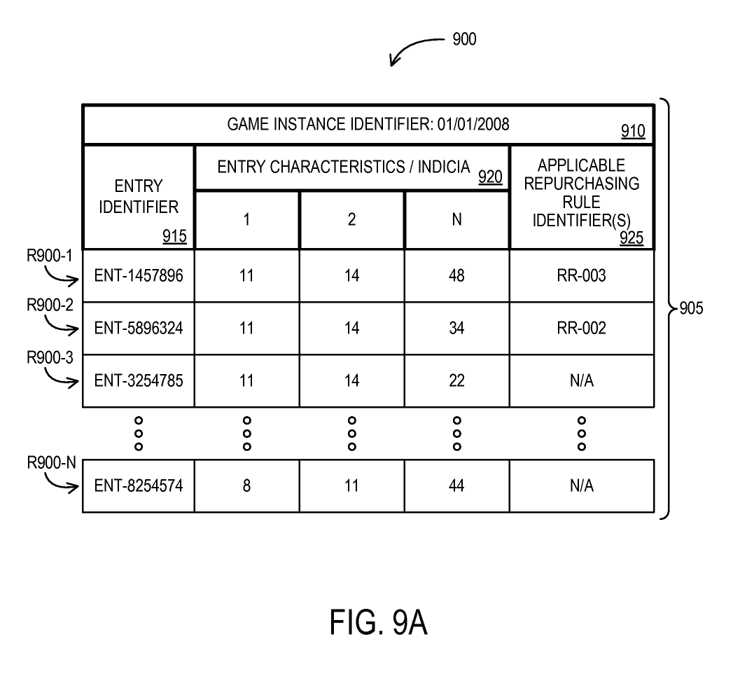

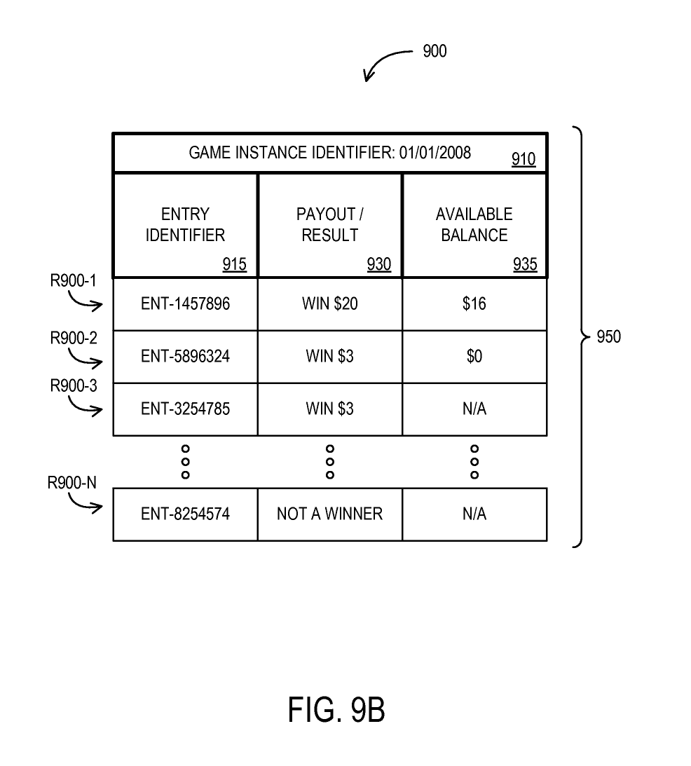

FIGS. 9A and 9B illustrate an embodiment of an Entry Status Database 900 that includes an Entry Information Table 905 and an associated Entry Payout Table 950. In particular, the Entry Status Database 900 corresponds to the game identifier “GM-001”, and shows the results for the entries concerning the game instance of Jan. 1, 2008, which has game results that are shown in row R800-1 of FIG. 8. Thus, referring to FIG. 9A, the database 900 includes a Game Instance Identifier 910 (of Jan. 1, 2008), an Entry Identifier field 915, an Entry Characteristics/Indicia field 920 and Applicable Repurchasing Rule(s) Identifier field 925. Also included in the entry status database, and shown in FIG. 9B, are a Payout/Result field 930 and an Available Balance field 935.

Referring to row R900-1 shown in FIGS. 9A and 9B, for the lottery entry having the entry identifier “ENT-1457896”, the entry characteristics indicia include the numbers 11, 14 and 48, the applicable repurchasing rule identifier is “RR-003”, the payout/result is $20, and the available balance is $16. Thus, the player holding that lottery entry won $20, of which, according to the selected repurchasing rule “RR-003” (defined in row R700-3 of the database 700 of FIG. 7), two entries are purchased in each of the next two drawings. Accordingly, the $20 payout is reduced by four dollars (because two one-dollar lottery entries will be purchased in each of two subsequent lottery games), and the balance shown in field 935 is $16. Referring again to FIG. 8, the player holding lottery entry ENT-1457896 will thus have two lottery entries sold to her in each of the lottery game instances of Jan. 4, 2008 and Jan. 8, 2008 (see rows R800-2 and R800-3 of FIG. 8) in accordance with the repurchasing rule “RR-003”.

Again referring to FIGS. 9A and 9B, rows R900-1 to R900-N include entry status and payout data for each entry associated with the game instance of Jan. 1, 2008 for the lottery game that corresponds to game identifier GM-001. In particular, row R900-2 illustrates that the lottery entry associated with entry identifier “ENT-5896324” has entry characteristics indicia of 11, 14 and 34, and that the applicable repurchasing rule identifier is “RR-002”. This entry has a payout/result of $3 (FIG. 9B), and the available balance of zero. Thus, the player holding that lottery entry won $3, but according to the selected repurchasing rule “RR-003” (which is defined in the database 700 of FIG. 7), three one-dollar entries are purchased in the next subsequent lottery game. Accordingly, the $3 payout is reduced by three dollars, and thus the balance shown in field 935 is $0. Referring again to FIG. 8, the player holding lottery entry ENT-5896324 will thus have three entries purchased for her in the subsequent game instance of Jan. 4, 2008 (see row R800-2 of FIG. 8) in accordance with the repurchasing rule “RR-002”.

Referring again to FIGS. 9A and 9B, row R900-3 illustrates that the lottery entry associated with entry identifier “ENT-3254785” has entry characteristics indicia of 11, 14 and 22, and that there is no applicable repurchasing rule in effect. This entry has a payout/result of $3, and the available balance field is not applicable in this case because the payout will go directly to the player as no repurchasing rules are in effect. Thus, the player holding that lottery entry won $3, and must redeem the lottery entry for that amount.

The final example shown in row R900-N illustrates a non-winning entry “ENT-8254574” that has no repurchasing rule associated with it. In this case, there is no repurchase rule in effect, and no payout to the player.

### Processes

Exemplary processes are described below that are presented solely for purposes of illustration. Although the description includes reference to some specific examples, features and aspects, the reader will understand that the scope of this disclosure is not limited to the particular combination and/or sequence of the particular features described in these examples. To the contrary, various elements are believed to be inventive independent of others.

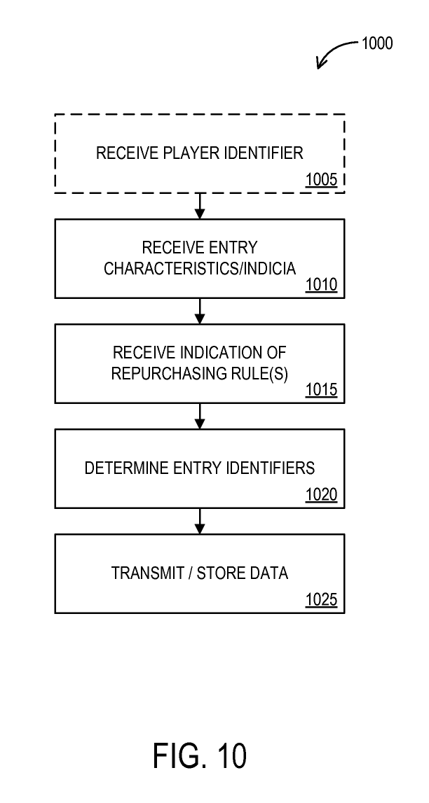

FIG. 10 is a flowchart of a lottery terminal process according to an embodiment. The lottery terminal may be, for example, a point-of-sale (POS) terminal located in a retail store for receiving lottery entry requests and dispensing lottery tickets (entries). In this embodiment, the lottery terminal receives (or determines) a player identifier 1005, receives entry characteristics/indicia 1010 from the player (for example, six numbers chosen from a field of forty-four numbers for a “Pick-6” lottery game) and receives an indication of at least one repurchasing rule 1015 selected by the player. The process also includes determining entry identifiers 1020 (for example, a player may pay $5 for five lottery entries to be printed on a lottery ticket, and each entry will have an associated entry identifier), and transmitting and/or storing the data 1025 (for example, the player identifier, entry indicia, repurchasing rules and entry identifiers may be stored in a lottery controller or other storage device). The step of receiving 1005 a player identifier is shown in dotted lines in FIG. 10 as this step may not be necessary in some embodiments.

For example, a customer enters a local convenience store and fills out a sense mark slip to select three sets of numbers for a weekly online lottery game (for example, “Pick-6”). On the sense mark slip, the player checks-off a box associated with a repurchasing rule indicating that if any of his three entries should result in a $3 prize being awarded, the three entries should be reentered in the following week's game and the initial $3 prize will be forfeited. The customer then hands the sense mark slip to a cashier (or lottery terminal operator), who scans in the information from the sense mark slip to a lottery terminal. The terminal then transmits the entry data to the operator controller, which registers the wager by storing the appropriate data (either in real time or in a subsequent batch process for a plurality of such wagers). The three requested lottery entries and/or sets of numbers are then printed out at the lottery terminal on a paper lottery ticket for the customer to retain as a record of his lottery play/wager.

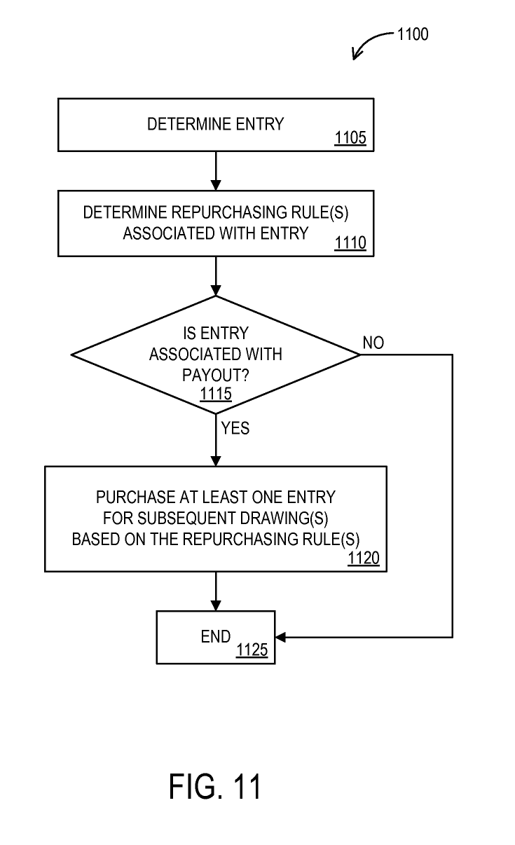

FIG. 11 illustrates a process 1100 for repurchasing lottery entries that includes determining (for example, receiving an indication of) a lottery entry 1105 (in some embodiments, an indication of the lottery entry may be stored), determining at least one repurchasing rule that is associated with the entry 1110 (for example, receiving an indication of the selection of two repurchasing rules from a player that include repurchasing conditions and corresponding repurchasing actions, and in some embodiments, the indication of the at least one repurchasing rule may be stored), and determining whether the entry is associated with a payout 1115 (that is, whether the lottery entry is a winning entry that is associated with a positive monetary value). If the lottery entry is associated with a payout, the process includes purchasing at least one entry for subsequent drawing(s) based on the repurchasing rule(s) 1120 and the process ends 1125. In some embodiments, the purchase of lottery entries in subsequent drawings based on one or more repurchasing rules is performed automatically, without the intervention of the player and/or without requiring any further instructions from the player. Referring again to FIG. 11, if, in step 1115, the lottery entry is not associated with a payout, then the process ends 1125.

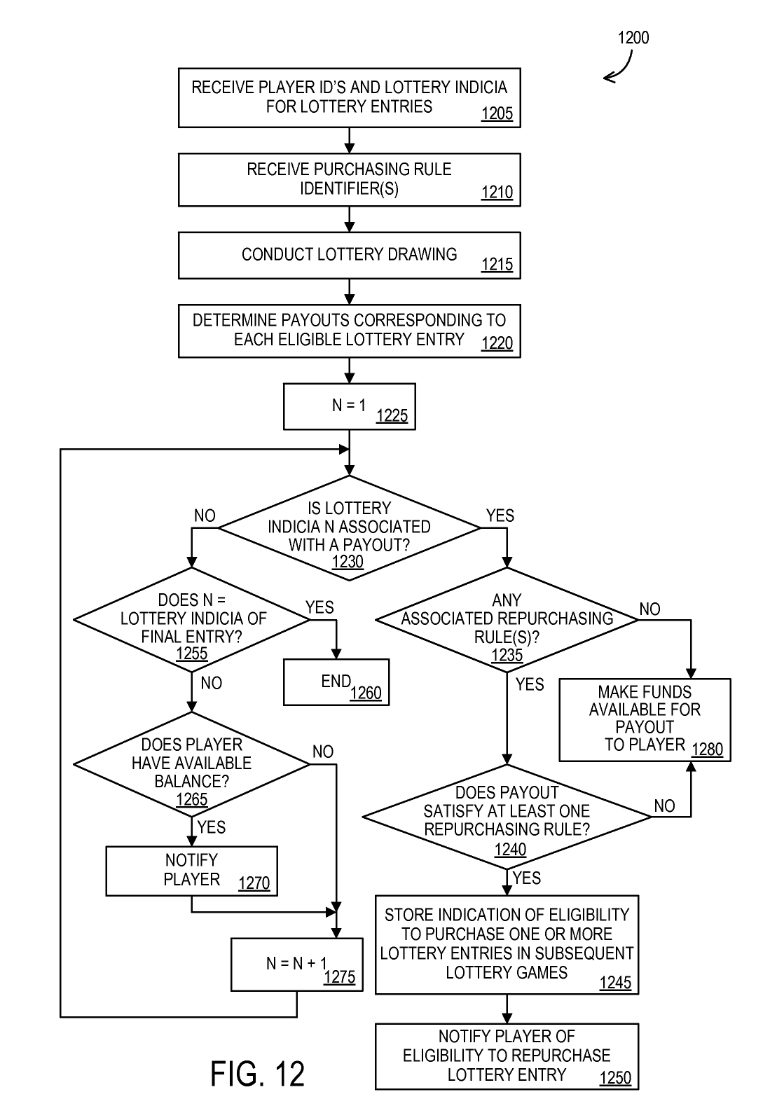

FIG. 12 illustrates an embodiment of a lottery operator controller process 1200 for repurchasing lottery entries for players based on repurchasing rules. The exemplary process includes a lottery operator controller receiving player ID and lottery indicia for each of a plurality of lottery entries 1205, and receiving at least one purchasing rule identifier 1210 associated with one or more of the lottery entries. The repurchasing rules, which include repurchasing conditions and corresponding repurchasing actions, may be chosen from a list (for example, a check box on a sense mark slip) or may otherwise be specified or selected by the players. The lottery controller may also receive various other data enabling the player's wager to be entered with respect to the upcoming lottery games/drawings. Generally, the information that is stored may include such data as the time and/or date and place of lottery entry purchase (a retailer ID may be included), and information specifying the player's entry(ies). For example, for a “Pick-6” type of game, information specifying or identifying the player's entry would include six numbers from a predetermined ordinal range (e.g. the range of {1 . . . 49}, inclusive). The numbers comprising the actual set(s) may be specified or selected by the player (as above) or randomly determined on the player's behalf by the lottery operator and/or lottery administrator (for example, via a “quick pick” process wherein numbers are randomly chosen for the player by a microprocessor or other device). Using the example above, the player's entries would include three sets {A, B and C} of six numbers, for example:

| | |
|---|---|
| Player Set A: | 09, 15, 22, 36, 37, 44 |
| Player Set B: | 12, 18, 19, 26, 33, 41 |
| Player Set C: | 11, 22, 33, 44, 45, 46 |

Referring again to FIG. 12, the process includes conducting the lottery drawing 1215, and determining the payouts corresponding to each eligible lottery entry 1220. For example, a player may be presented with a plurality of repurchasing rules from which he may be allowed to pick one or more preferred repurchasing rules for reinvesting any payouts (winning lottery entry amounts) in the purchase of one or more other (subsequent) lottery entries in one or more subsequent lottery games. For example, at a predetermined time subsequent to the players' lottery entries being registered by the lottery operator controller, a lottery drawing is held and the result of the drawing is determined. Using the “Pick-6” example set forth above, the lottery operator/administrator randomly determines six winning numbers from the predetermined set. According to some embodiments, the determination of a winning set of symbols/indicia may comprise determining the winning set from more than one set of indicia (for example, as in a Powerball® lottery game). For example, the winning numbers may be determined to be:
Winning Set 1: 09, 13, 16, 30, 37, 44

After the winning set is determined, information corresponding to the winning set is input, entered into, and/or received by the operator controller in order to determine the payouts that correspond to eligible lottery entries. Payouts may be associated with those lottery entries whose characteristics match (at least somewhat, or at least a portion of) the characteristics of the winning set. For example, using the “Pick-6” game, the following payout table may be used to determine payouts for player entries:

| Characteristics | Payout |
|---|---|
| Match 0/6 | No payout |
| Match 1/6 | No payout |
| Match 2/6 | No payout |
| Match 3/6 | Win $3 |
| Match 4/6 | Win $50 |
| Match 5/6 | Win $2,000 |
| Match 6/6 | Win Jackpot/Top Prize |

Using the examples above of Winning Set 1 and the Player Set A in conjunction with the above pay table, it is determined that the player has qualified for a $3 payout. This is so because the numbers of Player Set A match three of the numbers of Winning Set 1, as indicated below by the highlighted numbers:

| | |
|---|---|
| Winning Set 1: | 09, 13, 16, 30, 37, 44 |
| Player Set A: | 09, 15, 22, 36, 37, 44 |

And therefore, with reference to the above paytable:

| | |
|---|---|
| Match 3/6 | Win $3 |

Following the payout determination and/or assignment, the operator controller stores an indication of the associated payout in a data record associated with the corresponding entry. Accordingly, if/when the lottery entry is later presented for redemption by a player, the operator controller may access the data record based on the entry identifier in order to determine the actual payout.

Referring again to FIG. 12, the process 1200 next includes determining whether a given lottery entry is in fact associated with a payout 1230 (vs. the actual amount of payout, if any, as above) by accessing the payout data in the corresponding record. In particular, for the first lottery entry 1225 (when N=1), the method determines if the lottery indicia N is associated with a payout 1230. (In some embodiments, an indication that a lottery entry is associated with a payout may be generally recorded in the data record associated with that entry, for example, as a “yes/no” data flag versus data defining the actual amount of the payout). If so, a determination is made whether that lottery entry is associated with at least one repurchasing rule 1235. If it is, then a determination is made whether the payout for that lottery entry satisfies the at least one repurchasing rule 1240, and if so, an indication is stored 1245 of the eligibility to purchase one or more lottery entries in subsequent lottery games. (In some embodiments, a purchase of one or more lottery entries in one or more subsequent lottery games is automatically initiated without any further action or further input from the player.) In this example process, the player is notified 1250 that she is eligible to repurchase at least one lottery entry.

Referring again to step 1230 shown in FIG. 12, if the lottery indicia N is not associated with a payout, then the indicia is checked 1255 to determine if the last or final lottery entry for that lottery game has been examined, and if so the process ends 1260. If the lottery entry is not the last one to be checked, then a determination is made whether the player has an available balance 1265, which may exist due to prior lottery entry winnings, and if so, the player is notified 1270. After notification, or if there is no available balance, the value of N is incremented 1275 so that the next lottery entry can be checked in step 1230 to see if it is associated with a payout. It should be understood that the notification given to the player in step 1270 may include a notice that a portion of the available balance will be used to purchase a lottery entry in a subsequent lottery game, depending on whether an appropriate repurchasing rule is in effect or not.

Referring again to step 1230, if a lottery entry is associated with a payout, but there are no repurchasing rules associated with that lottery entry 1235, then funds are made available 1280 for payout to the player when the player redeems that lottery entry. In addition, if a repurchasing rule is in effect 1235, but the payout does not satisfy the rule 1240, then funds are made available to the player 1280.

For example, if it is determined that a lottery entry is (i) associated with a payout and (ii) associated with one or more repurchasing rules, the operator controller may then determine whether in fact to sell a subsequent entry (or entries) based on the particular repurchasing rule to the player, among other possible outcomes depending on the particular repurchasing rule. For example, the repurchasing rule may define certain repurchasing conditions that must be met or otherwise apply in order for the operator controller to take one or more corresponding repurchasing actions to sell one or more lottery entries for a subsequent lottery drawing to a player. Various repurchasing rule criteria are included herein below, as well as discussed above with regard to FIGS. 5 and 7.

According to some embodiments, the execution of an automated repurchase will result in an “available balance” (see FIG. 9B) associated with the initial entry to be incrementally reduced. For example, whereas $1 will purchase an entry in a subsequent drawing, the payout associated with the initial entry may be reduced to fund such a purchase. Alternatively, the “available balance” associated with a lottery entry may comprise a non-monetary “game unit” balance. For example, where $2 is required to purchase an entry for a given lottery game, and an initial lottery entry is determined to be associated with a $10 prize, the initial lottery entry may be determined to be associated with an initial lottery game balance of 5 entries.

According to some embodiments, the balance may be decremented on a per-unit basis (whether monetary or not) as that balance is utilized to purchase one or more subsequent lottery entries. Alternatively, the available balance associated with a given lottery entry may “carry-over” from one lottery game drawing to the next (pursuant to a repurchasing condition and corresponding repurchasing action), with the available balance being decremented appropriately between each drawing (that is, the data record for a given lottery entry carries over from one lottery drawing to the next, with the associated available balance being decremented along the way).

If it is determined that the repurchase of one or more lottery entries is authorized, in some embodiments the lottery operator controller registers the player's eligibility for the subsequent lottery game by storing the appropriate data relative to the subsequent game, in a manner similar to the player's initial lottery entry. According to some embodiments, the player may be notified at this point that his or her initial lottery entry has qualified for an initial lottery prize and that the initial lottery prize has been applied to one or more subsequent lottery entries. Such notification may be via e-mail, web site, outbound VRU, and the like.

According to some embodiments, a repurchasing rule may enable the subsequent purchase of more than one lottery entry (or more than one instance of a lottery entry) over more than one lottery game or lottery drawing. For example, a player who is eligible to receive a ten-dollar ($10) payout as a lottery prize from an initial lottery game may enact a repurchasing rule that includes repurchasing conditions and corresponding repurchasing actions that allow for a serialized lottery entry over ten (10) subsequent lottery game instances. Accordingly, the lottery operator controller may determine whether an ongoing balance associated with an initial lottery entry is to be employed to purchase one or more subsequent lottery entries.

For example, using the $10 payout example recited above, a repurchasing pattern may be:

| Game/Drawing | Result | Payout | Balance |
|---|---|---|---|
| 1 | Win $10 | $10 | $10 |
| 2 | No payout | 0 | $9 |
| 3 | No payout | 0 | $8 |
| 4 | No payout | 0 | $7 |
| 5 | No payout | 0 | $6 |
| 6 | No payout | 0 | $5 |
| 7 | No payout | 0 | $4 |
| 8 | No payout | 0 | $3 |
| 9 | No payout | 0 | $2 |
| 10 | No payout | 0 | $1 |
| 11 | No payout | 0 | $0 |

### Lottery Ticket

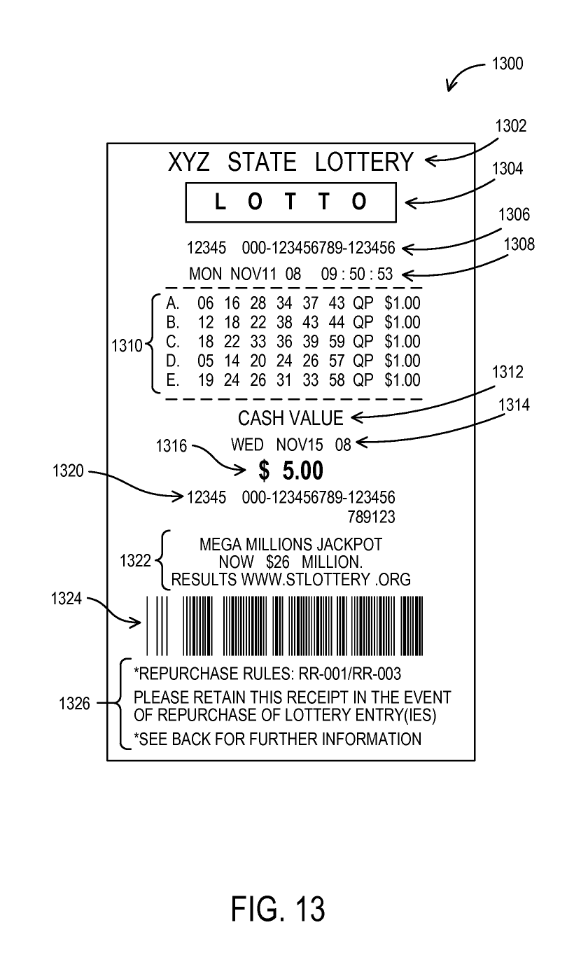

FIG. 13 is a view of a Lottery Ticket 1300 or lottery entry configured according to an embodiment, which a player would retain as a receipt after choosing lottery game indicia and paying an entry fee. The lottery ticket 1300 includes a lottery administrator name field 1302, the name of the particular lottery game 1304 (“LOTTO”, which in this example is a Pick-6 type of lottery game), a lottery ticket serial number identifier 1306, and the time and date of lottery entry purchase 1308. The lottery ticket serial number 1306 may distinguish lottery ticket 1300 from all other existing lottery tickets, or from all other lottery tickets sold in conjunction with a particular lottery, or within a particular period. The lottery ticket serial number 1306 may thus comprise a number alone, a number combined with letters or other symbols, or some other distinguishable group of characters.

The lottery ticket 1300 of this example contains three (3) lottery entries 1310 in rows “A” to “C”, wherein each lottery entry cost the player $1 (one dollar) as shown. The selected lottery game indicia for each lottery entry correspond to combinations of six (6) numbers that have been chosen from a field of numbers (which in this lottery game are the numbers in the range of 1 to 60), and which have been selected in this example by a “Quick Pick” (indicated by the abbreviation “QP” at the end of each row of numbers) method (wherein a processor, for example, randomly chooses the number combinations for the player). Of course, the player may choose the numbers for each lottery entry manually if desired, for example, by using a lottery selection sheet. In addition, it should be understood that other embodiments may include more or fewer selected playing symbols depending on the type of lottery game being played.

The lottery ticket 1300 also includes a type of payout 1312, the date of the drawing 1314, the price paid for the lottery entries 1316 (which in this example is three dollars ($3) for the three entries), a retailer identifier serial number 1318, a player identifier 1320 (which corresponds to the player identifier for “Susan Jones” shown in FIG. 6), and a lottery game information area 1322 (which may include information such as the current jackpot amount and instructions for obtaining lottery results information). The lottery ticket 1300 may also include a barcode 1324 for uniquely identifying the lottery entries, and a “Repurchasing Rules” field 1326 for identifying which repurchasing rules, if any, are in effect for the lottery entries 1310.

The Repurchasing Rules field 1326 includes repurchasing rule codes RR-001 and RR-003. The corresponding repurchasing actions are found in the repurchasing rules database 700, and the instruction for RR-001 requires that if the initial payout for an entry is $3 and the jackpot is over $10 million dollars, then purchase one entry (e.g. entry “A” of lottery ticket 1300) at $1 each in each of the next three drawings; whereas the instruction for RR-003 is if the initial payout is less than or equal to $20, then purchase two entries (e.g. entries “A” and “B” of lottery ticket 1300) in each of the next X drawings until the initial payout is exhausted. These repurchasing rules may be implemented in any order acceptable to the lottery administrator, but in an implementation would be implemented in rule order (for example, RR-001 would be implemented first if the conditions are met, then rule RR-002, RR-003, etc.). The Repurchasing Rules field 1326 also includes a message to the player to “Retain this lottery receipt in the event of repurchase of lottery entry(ies) for future lottery game(s)”, and an instruction to the player to “See back of ticket for further information”. Thus, the reverse side of the lottery ticket 1300 (not shown) may contain information for the player such as descriptions of the lottery rules that have been indicated on the front (in this example, descriptions of the repurchasing rules RR-001 and RR-003 that include repurchasing conditions and repurchasing actions), information concerning how to redeem any winning lottery entries for prizes, the odds of winning any particular lottery prize, the address or other contact information of the lottery administrator, a deadline for claiming lottery prizes, and the like.

For the example shown in FIG. 13, on the date of the drawing 1314 of Nov. 15, 2008, which date is determined by the lottery operators, a winning number combination may be determined in one of various manners known to those of ordinary skill in the art. After the winning numbers are determined (e.g., drawn), the holder of lottery ticket 1300, which is a bearer instrument, may compare the lottery entry number combinations 1310 to the winning number combination. If a required number of selected playing symbols of any of the rows “A” to “C” match playing symbol(s) included in the winning number combination, then the lottery ticket 1300 includes at least one winning lottery entry, pursuant to the rules of the particular lottery game. In such a case, one or more repurchasing rules may be activated if the appropriate repurchasing conditions are met so that one or more lottery entries are automatically purchased for the player in a subsequent lottery drawing according to at least one repurchasing action. Alternately, the player may present any winning lottery entries that do not trigger one or more repurchasing conditions to a lottery retailer or to the lottery administrator in return for payment of the appropriate prize amount.

The lottery ticket 1300 may also include further information, such as a date or deadline by which a prize associated with a winning lottery ticket must be claimed (after which date or deadline the prize is abandoned/lapsed or is otherwise forfeited to the lottery administrator), or any other applicable date. One of skill in the art would also recognize that other types of lottery prizes could be awarded, and that a price for the lottery ticket 1300 may be determined in accordance with any known pricing method (for example, a $1 (one dollar) payment may entitle a player to two lottery entries on a lottery ticket associated with a particular type of lottery game). The pricing method, for example, may take into account the projected number of lottery tickets that will be sold in a given period for the type of lottery game being offered, the projected number of lottery players, the size of the jackpot, and other factors.

The lottery ticket 1300 may be marked or altered in some recognizable way to make it clear that at least one repurchasing rule 1326 is in effect. For example, a physical marking of the ticket such as that shown to include repurchasing rule codes and/or other identifiers, perhaps with an ink color different than that of the ink used to print other portions of the lottery entry, or by using another permanent substance, could be used. Furthermore, the lottery ticket serial number 1306 and barcode 1324 could be stored in a database along with the applicable repurchasing rules and lottery entries 1310 for future retrieval. Thus, lottery tickets for a particular lottery game that include repurchasing rules may be printed in different sizes, colors, shapes, or other have other characteristics that distinguish them from ordinary or typical lottery tickets so that such tickets are easily recognizable by lottery retailers and players.

In some embodiments, a lottery ticket having entries that do not include corresponding repurchasing rules may be updated after purchase to include repurchasing rules. For example, a lottery administrator may permit the player to access an on-line account by logging into a personal lottery account accessible via the internet, prior to the lottery drawing date and time 1314, and designate one or more of the lottery entries “A” to “C” to be associated with one or more repurchasing rules. Such a change may, in one embodiment, be made until a predetermined cutoff time, wherein the predetermined cutoff time precedes the drawing time and date at which the winning number combination for the lottery game is determined. In addition, in this case a special receipt may be provided which could be mailed or otherwise provided to the player, for example a data file could be emailed to the player that may be printed out using a home computer and printer, so that the player has a record of the repurchasing rules that are in effect. Data entries could also be made to various databases if a repurchasing rule is in effect and the results of the lottery game cause a subsequent purchase of a lottery entry for the player to be made. Such a process would prevent double prize awards from occurring, for example, if the player inadvertently presents the winning lottery entry from the initial lottery game to a lottery retailer and receives a payout and also receives one or more subsequent lottery entries in a second lottery game. Such data entries thus prevent a retailer from providing a payout that is not deserved.

### Repurchasing Rules

Some exemplary repurchasing rules including repurchasing conditions and repurchasing actions are described herein, and others will be readily apparent to those of ordinary skill in the art upon consideration of this disclosure. In addition, various combinations of repurchasing conditions and repurchasing actions may be provided for use together as deemed practical for any desired application. Such combinations may be generated by a lottery administrator, a lottery player, or other entity or person.

For example, according to a first rule type, a player may elect to automatically purchase (or repurchase) lottery entries for a subsequent lottery game if and/or when the result of the initial lottery event indicates that the player is eligible for an initial qualifying payout and:
A. (1) The player's total initial winnings are less than (or equal to) a player-established amount (e.g. less than or equal to $20.00), or (2) the player's initial winnings are less than or equal to an amount established by a lottery administrator (e.g. the player's winnings are equal to one of the two lowest available prizes in the initial game).
B. The player's total winnings are determined in a particular manner (e.g. the player's initial lottery entry contains game indicia that matched 3 of 6 numbers drawn in an online game) or are determined to posses one or more particular attribute(s) (e.g. the player's initial game entry matched only a drawn bonus number, resulting in a $2 prize for the initial entry).
C. The total jackpot for a subsequent drawing is (or is projected to be) at least a certain minimum amount (e.g. at least $50M).
D. A combination of [A(1)+C] or [A(2)+C] as described above.
E. The jackpot for a subsequent drawing is a “residual” or a “roll-over” jackpot (for example, when no lottery entry is determined to have won a top prize in the initial lottery drawing).
F. A combination of [A(1)+E] or [A(2)+E], as described above.
G. If a total payout for all of a player's entries in the initial lottery game is not greater than $X, where the player has purchased a plurality of lottery entries for the initial lottery game and/or more than one of the player's initial lottery entries results in a prize in the initial lottery game (e.g. the player has purchased five lottery entries, and each of two of the five lottery entries qualifies for a $2 prize).
H. If it is determined that a player has not redeemed one or more winning lottery entries from the initial lottery game by a predetermined deadline. For example, a repurchasing rule may state, “All $1 winners from Wednesday's lottery game may be automatically re-entered into the immediately-following Saturday lottery drawing if not redeemed by 11:00 PM on the first Friday following Wednesday's game.” According to some embodiments, the automatic re-entry in a subsequent lottery game may occur after a predetermined period of time elapses from a lottery drawing (or after a number of intervening lottery games) N, with N being greater than the amount of time (or lottery games) between a first lottery game and an immediately-successive lottery game/drawing (e.g. N may equal two weeks or five lottery drawings). According to some embodiments, N may be selected or otherwise specified by a player at the time of purchasing his/her initial lottery entry.
I. If it is determined that:
   a. no more than X number of lottery entries with respect to a given subsequent lottery drawing is/are associated with a particular player number/indicia combination (e.g. if entered in a subsequent lottery game, the player's combination would be unique with respect to that lottery game instance).
   b. based on the number of combinations corresponding to the player's combination that have been sold with respect to the second lottery game, the player would receive (or share) at least $X, should the player's combination be selected as a winning combination in the second lottery game. For example, the repurchasing rule may include an instruction that recites: “Don't reenter my lottery numbers, unless I would receive at least $X should I win.”
J. According to some embodiments, the determination of whether to subsequently repurchase or reenter a given lottery entry from a first lottery game into a second lottery game may be made based on whether or not the entry from the first lottery game has been presented for redemption prior to the second lottery game. For example, a repurchasing rule may state something to the effect of: “If winnings from a weekly lottery game are not redeemed within seven days, $1 of such winnings per lottery drawing will be reentered into each subsequent weekly lottery game, until either (i) the original lottery entry is redeemed (for the original win amount, less any $1 decrement(s) used to pay for subsequent lottery entries) or (ii) such lottery winnings are fully decremented from the original winnings. Thus, the ability to rollover winnings from one lottery drawing/game to the next lottery game may be presented as a default option to the player, with the player enabling deactivation of the rollover upon redemption of his/her original lottery entry. Therefore, the player's decision to redeem or repurchase/reenter need not be made at the time of purchasing his/her original lottery entry.

### Repurchasing Actions

According to a second repurchasing rule component, a player may elect to purchase (or repurchase) lottery entries for one or more subsequent lottery games in a preferred or particular manner, according to one or more player-selected repurchasing action options. For example, a player may specify particular repurchasing actions (which were discussed above with regard to FIG. 7) such as the following:
1. At the time of purchasing a lottery entry for the lottery initial game, register a request that should the player win a prize of $Z, (for example, $20), then purchase X lottery entries (for example, 5 lottery entries) per lottery drawing over the subsequent Y (for example, four) lottery drawings.
2. At the time of purchasing a lottery entry for the initial lottery game, the player may register a request that should the player win a prize of $Z (e.g. $7), purchase X lottery entries (e.g. 1 entry) per lottery drawing until the jackpot reaches a minimum of $Y (e.g. $20 Million), then purchase twice the lottery entries per lottery drawing thereafter until the initial $Z is exhausted (or until another lottery prize is won).
3. At the time of purchasing a lottery entry for the initial lottery game, the player may register a request that should the player win a prize at or below $X (e.g. $10), purchase Y lottery entries (e.g. 2 lottery entries) per drawing until the jackpot is won, then set the redemption value of the original ticket to the following:

(The original redemption value)−(Price of all subsequently purchased entries)
For example, a player might win $7 as the result of an initial lottery game, with $1 per subsequent lottery game of the original $7 being allocated to each game thereafter until either (i) the jackpot is awarded or (ii) the $7 is exhausted.
4. A combination of items [2+3], as described above.
5A. At the time of purchasing more than one lottery entry for the initial game, the player may register a request that should the player win a prize (e.g. any prize, any prize below $X, any prize other than the jackpot, etc.) in the initial lottery game, then purchase all subsequent lottery entries in increments of the original purchase for an indefinite number of drawings.
5B. Using the repurchasing manner of 5A above, the player's initially purchased lottery entries/numbers may be automatically renewed/reentered for each lottery game subsequent to the initial lottery game.
6. At the time of purchasing a lottery entry for the initial lottery game, the player may request and receive one or more (e.g. 2) inactive lottery entries for a later game, which may become active/eligible for the later lottery game should the player qualify for a prize in the initial lottery game.
7. At the time of purchasing at least one lottery entry for the initial game, a lottery operator may offer the player one or more predefined repurchase packages or options. For example, “option A” might enable the player/purchaser to repurchase lottery entries in a subsequent lottery drawing/game with 100% of initial lottery winnings (up to, for example, $20) being rolled-over into the second lottery drawing/game, while “option B” might enable the player to purchase one lottery entry (e.g. at $1 each) in each of several subsequent lottery drawings (e.g. for up to $20, and thus up to 20 lottery drawings).

### Additional Embodiments

According to some embodiments, a lottery operator may employ an interactive outbound calling system to automatically place a phone call to (or otherwise notify) the lottery player so that the player may verify or confirm that he would like to purchase lottery entries for a subsequent lottery game out of his lottery winnings from an initial lottery game. If the player does not answer or respond to the phone call (or e-mail, or other mode of notification), then a default procedure may be enacted by which lottery entries for the subsequent lottery game(s) are (or are not) purchased on the player's behalf. In one embodiment, the player could provide his phone number (or other mode and/or address for communication) at the point of lottery entry purchase (for example, the player may make a selection via a sense mark strip).

According to some embodiments, a player may use a lottery operator web site to view or monitor the status of a given initial and/or subsequent lottery entry. For example, the player may enter his or her lottery ticket/entry identifier and/or player identifier to the web site in order to view or otherwise access information pertaining to the status of his or her lottery entry(ies). For example, the system may include means for charting historical data associated with the players' lottery entry(ies) including such data as the date of purchase of the initial entry(ies), the result/status of the initial entry(ies) with respect to an initial lottery game, and lottery entry and/or result information for one or more subsequent lottery entry(ies) resultant of lottery winnings from the initial lottery entry(ies). This may include data such as subsequent lottery game/drawing results, payouts, redemption statuses, and the like. In some embodiments, a player may use a lottery operator web site to select or otherwise identify repurchasing rules. That is, the player need not select one or more repurchasing rule(s) at the point of his initial lottery ticket purchase, so long as the player does so prior to the initial lottery game/drawing. For example, a player may purchase a lottery ticket at a retail store and subsequently visit a lottery operator web site, enter his or her player identifier (for example, her e-mail address) and/or lottery entry identifier in order to chose and/or configure one or more repurchasing rule(s). In addition, with regard to lottery entry repurchase notification and/or confirmation, the lottery player may also be able to utilize the lottery operator website to provide instructions and/or select preferred methods of communication for how and when to notify the player regarding the repurchase of lottery entries from initial lottery entry winning amounts.

According to some embodiments, a lottery operator may require a minimum number of lottery entries to be purchased with respect to an initial lottery drawing/game in order for the player to be eligible for automatic lottery entry repurchase in one or more subsequent lottery game(s). For example, a lottery operator may require that: (i) a minimum of three (3) lottery entries at $1 each be purchased for the initial lottery game/drawing; (ii) for each group of three lottery entries, should any one (and only one) of the three entries qualify for a $3 prize in the initial lottery game/drawing, then (iii) three additional lottery entries will be automatically entered in a subsequent lottery game/drawing, should the player indicate such when purchasing one or more of the lottery entries for the initial lottery game/drawing. According to some embodiments, the lottery operator may further wish to limit reentries/repurchasing to only those instances where no jackpot winner is determined (for example, for accounting purposes and/or in deference to player wishes).

In accordance with some embodiments, it may be beneficial for a lottery operator and/or lottery administrator to require a minimum player expenditure on an initial number of lottery entries, such that the initial expenditure is equivalent to the lowest available prize for a given lottery game. For example, where the lowest available prize for a given lottery game is $3, the lottery operator/administrator may require that a player purchase $3 worth of lottery entries in the initial lottery game in order to be eligible for (e.g. only) the minimum prize to be applied to a second, later lottery game/drawing.

According to some embodiments, the indication of one or more applicable lottery entry repurchasing rules may be received via a dedicated sense mark slip, independent of any medium containing player lottery entry information. For example, a dedicated slip provided at or near the lottery retailer terminal may include a number of check-off areas, each corresponding to all or a portion of a repurchasing rule. Accordingly, a player may utilize such a slip to select or specify various parameters comprising his or her particular repurchasing rule(s). For example, a first area of the slip might enable the player to select or specify a first parameter or condition to be associated with the repurchasing rule, such as the maximum prize that may be utilized to repurchase lottery entries, and a second area of the slip might enable the player to select or specify a second parameter or action to be associated with the repurchasing rule (for example, the second parameter could be the number of lottery entries to purchase for one or more subsequent drawings, or could be additional player indicia, and the like). Furthermore, the player could be permitted to configure one or more repurchasing rules by using a lottery operator website, for example, after the player has initially purchased his or her lottery entry.

According to some embodiments, a method, system and apparatus are operable to provide for determining a result associated with a first lottery drawing, determining, based on the result, an initial payout associated with an entry in the first lottery drawing, and determining, based on a repurchasing condition, whether to utilize at least a portion of the initial payout to purchase at least one entry in a second lottery drawing. In this implementation, the second lottery drawing occurs subsequent to the first lottery drawing, and the process includes utilizing at least a portion of the initial payout to purchase at least one entry in the second lottery drawing pursuant to a repurchasing action. In some embodiments, the repurchasing condition comprises one or more of

a) Player instruction/acquiescence (i.e. player opt-in);

b) an indication of a maximum payout;

c) an indication of a minimum payout; or

d) an indication of an actual total payout.

Furthermore, in some variations of the above, a corresponding repurchasing action may include or indicate one or more of:

a) an expenditure per drawing;

b) a duration of time;

c) a number of drawings;

d) preferred entry information (for example, preferred game numbers, preferred game(s), and the like); and

e) one or more terminating criteria (for example, do not repurchase lottery entries if a jackpot is awarded, or do not repurchase lottery entries if the accrued payout(s) are greater than $X, and the like.).

In some variations of the above described processes, determining whether to utilize at least a portion of the initial payout to purchase at least one lottery entry in a second lottery drawing comprises determining a total available balance associated with the lottery entry in the first lottery drawing, and utilizing at least a portion of the available balance to purchase at least one lottery entry in the second lottery drawing.

According to some embodiments, a lottery operator may provide lottery retailers with an incentive such as an additional fee or an enhanced commission for each lottery entry sold that includes at least one repurchasing rule. For example, a lottery administrator may provide lottery retailers with a higher profit margin for selling such lottery tickets (having repurchasing conditions and corresponding repurchasing actions selected by players). For example, a lottery administrator may pay the lottery retailer a fee of five cents (a standard commission) for selling a conventional lottery entry, but may pay the lottery retailer a fee of eight cents (an enhanced commission) for selling lottery entries that include repurchasing rules. In some embodiments, when a subsequent lottery entry is purchased based on the execution of repurchasing rules (a repurchasing condition and corresponding repurchasing action), a lottery administrator may authorize a credit to be made to an account of the lottery retailer, or may make a payment equal to the commission the retailer would have made had the player purchased the second lottery entry directly from the retailer. In some embodiments, when a subsequent lottery entry is purchased based on a repurchasing condition and repurchasing action, a lottery administrator may credit an account of a lottery retailer with a commission equal to that earned when the retailer sold the initial lottery entry to the player. In this case, the lottery retailer will not have any lost any opportunity for sales commissions associated with selling lottery entries that include automatic repurchasing rules because any lottery entries automatically purchased for the player based on the repurchasing rules earn the retailer a commission. Thus, a lottery retailer will not be penalized for selling lottery entries to players that include repurchasing conditions and corresponding repurchasing actions, instead being rewarded for selling such lottery entries, and in some embodiments, also earning a commission if a player holding such a lottery entry automatically repurchases at least one second lottery entry in a subsequent lottery game.

### Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning. Finally, unless a claim element is defined by reciting the word “means” and a function without reciting any structure, it is not intended that the scope of any claim element be interpreted based on the application of 35 U.S.C. §112, sixth paragraph.

Although the present invention has been described with respect to preferred embodiments thereof, those skilled in the art will note that various substitutions and modifications may be made to those embodiments described herein without departing from the spirit and scope of the present invention.

What is claimed is:

1. A method, comprising:
determining a result associated with a first lottery game;
determining, by a lottery controller, based on the result, an initial payout associated with a lottery entry of a player of the first lottery game;
determining, by the lottery controller, that at least one repurchasing condition is satisfied, the at least one repurchasing condition comprising a requirement that the initial payout is a lower tier prize amount associated with the first lottery game; and
after determining the at least one repurchasing condition is satisfied, automatically selling, by the lottery controller to the player, at least one second lottery entry of a second lottery game in exchange for at least a portion of the initial payout, in accordance with at least one repurchasing action corresponding to the repurchasing condition.

2. The method of claim 1, wherein the at least one repurchasing condition further comprises a requirement that a predetermined minimum jackpot amount be associated with the second lottery game.

3. The method of claim 1, the at least one repurchasing action comprising at least one of: limiting an expenditure per drawing for subsequent lottery entries, limiting the purchase of subsequent lottery entries to purchases during a predetermined duration of time, or limiting the purchase of subsequent lottery entries to a predetermined number of subsequent lottery drawings.

4. The method of claim 1, wherein the at least one repurchasing condition comprises a player indication of acceptance of an opt-in provision.

5. The method of claim 1, wherein the at least one repurchasing action comprises a player instruction to reinvest all of the initial payout in the at least one second lottery entry.

6. The method of claim 5, the player instruction further comprising at least one of:
a selection of a preferred lottery game,
preferred lottery game entry indicia,
a threshold amount to apply to the purchase of any one subsequent lottery entry,
an indication of a maximum expenditure per subsequent lottery game,
a number of subsequent lottery games governed by the repurchasing conditions, or
at least one termination criteria for ending the purchase of subsequent lottery entries.

7. The method of claim 1, further comprising terminating the selling of subsequent lottery game entries to the player if at least one of: a lottery jackpot is awarded; or an accrued lottery payout is awarded.

8. The method of claim 1, wherein the at least one repurchasing condition comprises a provision requiring at least one of:
that a player's total winnings are less than a predetermined amount,
that a player has not redeemed at least one lottery entry of the first lottery game by a predetermined deadline, or
that a player purchased a predetermined minimum amount of lottery entries in the first lottery game.

9. The method of claim 1, wherein the at least one repurchasing action comprises reinvesting the initial payout over a preselected number of lottery entries in at least one subsequent lottery game until a jackpot is won or until the initial payout is exhausted.

10. The method of claim 1, wherein the at least one repurchasing action comprises at least one of:
selling all subsequent lottery entries in increments of a purchase price for the lottery entry of the first lottery game for an indefinite number of subsequent lottery drawings until the initial payout is exhausted,
reinvesting the initial payout as specified by the player by using the same lottery game indicia on subsequent lottery entries as used on the lottery entry of the first lottery game, or
reinvesting the initial payout by selling a number of lottery entries as specified by the player.

11. The method of claim 1, further comprising authorizing a commission to a lottery retailer if the at least one second lottery entry is sold to the player, wherein the lottery retailer was responsible for selling the lottery entry of the first lottery game to the player.

12. The method of claim 1, further comprising selling to the player at least one subsequent lottery entry if a total available balance associated with the player is sufficient to make such a purchase.

13. The method of claim 1, further comprising authorizing an enhanced commission for a lottery retailer for the sale of each lottery entry of the first lottery game that includes at least one repurchasing condition.

14. The method of claim 1, further comprising, prior to determining a result associated with the first lottery game, receiving at least one of a player identifier, a lottery entry identifier, lottery game entry indicia, an indication of the at least one repurchasing condition, or an indication of the at least one repurchasing action.

15. The method of claim 1, wherein the lower tier prize amount comprises at least one of a lowest tier prize amount of the first lottery game, a multiple of the lowest tier prize amount of the first lottery game, or a prize amount designated by a lottery administrator.

16. A computer readable storage device storing instructions configured to direct a processor to:
determine a result associated with a first lottery game;
determine, by a lottery controller, based on the result, an initial payout associated with a lottery entry of a player of the first lottery game;
determine, by the lottery controller, that at least one repurchasing condition is satisfied, the at least one repurchasing condition comprising a requirement that the initial payout is a lower tier prize amount associated with the first lottery game; and
after determining the repurchasing condition is satisfied, sell, by the lottery controller to the player at least one second lottery entry of a second lottery game in exchange for at least a portion of the initial payout, in accordance with at least one repurchasing action corresponding to the repurchasing condition.

17. The computer readable storage device of claim 16, in which the instructions for determining whether at least one repurchasing condition is satisfied further comprise instructions configured to direct the processor to require that a predetermined minimum jackpot amount is associated with the second lottery game.

18. The computer readable storage device of claim 17, in which the instructions for selling at least one second lottery entry further comprise instructions configured to direct the processor to receive a player indication of acceptance of an opt-in provision to repurchase lottery entries.

19. The computer readable storage device of claim 17, in which the instructions for selling at least one second lottery entry further comprise instructions configured to direct the processor to at least one of: sell at least one lottery entry for a preferred lottery game indicated by the player, utilize player selected lottery game entry indicia, apply a threshold amount to the purchase of any one subsequent lottery entry, provide an indication of a maximum expenditure per subsequent lottery game, purchase lottery entries in a number of subsequent lottery games governed by the repurchasing conditions, or utilize at least one termination criteria for ending the purchase of subsequent lottery entries.

20. The computer readable storage device of claim 17, which further comprises instructions configured to direct a processor to terminate the selling of subsequent lottery game entries to the player if at least one of: a lottery jackpot is awarded; or an accrued lottery payout is awarded.

21. The computer readable storage device of claim 17, in which the instructions for determining whether at least one repurchasing condition is satisfied further comprise instructions configured to direct the processor to require at least one of: that a player's total winnings are less than a predetermined amount, that a player has not redeemed at least one lottery entry of the first lottery game by a predetermined deadline, or that a player purchased a predetermined minimum amount of lottery entries in the first lottery game.

22. The computer readable storage device of claim 17, in which the instructions for selling at least one second lottery entry further comprises instructions configured to direct the processor to at least one of:
sell all subsequent lottery entries in increments of a purchase price for the lottery entry of the first lottery game for an indefinite number of subsequent lottery drawings or until the initial payout is exhausted,
reinvest the initial payout as specified by the player by using the same lottery game indicia on subsequent lottery entries as used on the lottery entry of the first lottery game, or
reinvest the initial payout by selling a number of lottery entries as specified by the player.

23. The computer readable storage device of claim 16, which further comprises instructions configured to direct a processor to authorize a commission for a lottery retailer if at least one subsequent lottery entry is sold to the player, wherein the lottery retailer is responsible for selling the lottery entry of the first lottery game to the player.

24. The computer readable storage device of claim 16, which further comprises instructions configured to direct a processor to authorize an enhanced commission for a lottery retailer for the sale of each lottery entry of the first lottery game that includes at least one repurchasing condition.

25. A lottery controller, comprising:
a processor;
a communications port operatively coupled to the processor; and
a data storage device operatively coupled to the processor and containing instructions configured to direct the processor to:
determine a result associated with a first lottery game;
determine, based on the result, an initial payout associated with a lottery entry of a player of the first lottery game;
determine that at least one repurchasing condition is satisfied, the at least one repurchasing condition comprising a requirement that the initial payout is a lower tier prize amount associated with the first lottery game; and
after determining the repurchasing condition is satisfied, sell to the player at least one second lottery entry of a second lottery game in exchange for at least a portion of the initial payout, in accordance with a least one repurchasing action corresponding to the repurchasing condition.
